(19) United States
(12) Patent Application Publication
(10) Pub. No.: US 2022/0132325 A1
(43) Pub. Date: Apr. 28, 2022

(54) BEAM CORRESPONDENCE METHOD AND APPARATUS, USER EQUIPMENT AND BASE STATION

(71) Applicant: BEIJING XIAOMI MOBILE SOFTWARE CO., LTD., Beijing (CN)

(72) Inventor: Juejia ZHOU, Beijing (CN)

(73) Assignee: BEIJING XIAOMI MOBILE SOFTWARE CO., LTD., Beijing (CN)

(21) Appl. No.: 17/310,426

(22) PCT Filed: Feb. 2, 2019
(86) PCT No.: PCT/CN2019/074617

§ 371 Date: Aug. 2, 2021

(51) Int. Cl. H04W 16/28; H04W 72/04

(52) U.S. Cl. CPC H04W 16/28; H04W 72/046; H04W 72/048

(57) ABSTRACT

A beam correspondence method includes: determining sweeping configuration information for a beam correspondence state, wherein the sweeping configuration information indicates that in the beam correspondence state, the user equipment performs a beam sweeping to re-determine a best matching beam pair when a relative position between an antenna module of the user equipment and the base station changes; in the beam correspondence state, triggering the beam sweeping according to the sweeping configuration information to obtain a beam correspondence result, wherein the beam sweeping is performed to re-determine the best matching beam pair; sending the beam correspondence result to the base station, so that the base station determines a transmission beam with reference to the beam correspondence result.

### TECHNICAL FIELD

The present disclosure relates to the field of communication technology, and in particular, to a beam correspondence method and apparatus, user equipment (UE), and a base station.

### BACKGROUND

A 5G NR (New Radio) has broadened new ranges of frequencies for transmission. The use of high-frequency spectrum is a feature of the 5G NR. The application of millimeter wave (mm wave) with a frequency above 6 GHz is the most typical.

In the millimeter wave application of a 5G NR system, a base station and user equipment (UE) use beamforming technology to transmit information to each other. The communication process is roughly as follows: a transmitter, such as the base station, uses a large-scale antenna array to send a high-frequency beam with a frequency above 6 GHz along a direction to a receiver, and after the receiver uses a millimeter wave antenna module to receive the high-frequency beam, the receiver establishes a communication connection with the transmitter, thereby transmitting and receiving information through the high-frequency beam.

In order to use beamforming, the base station and the terminal can use beam sweeping to detect which beam to be used for transmission can meet requirements of a maximum transmit power in a certain direction (e.g., Effective Isotropic Radiated Power, EIRP) and a spherical coverage.

In the 5G millimeter wave, currently determined frequency bands are all TDD (time division duplexing) frequency bands. Since the TDD frequency bands have a feature as uplink and downlink reciprocity, that is, because the uplink and downlink transmission are performed in the same frequency band, channel conditions related to the uplink and downlink transmission are similar. That is to say, the best beam for downlink transmission should also be the best beam for uplink transmission, thus for 5G millimeter wave, it is recommended for UE to achieve beam correspondence capability. That is, a beam used by the UE for downlink reception is also used for uplink transmission by the UE, thereby avoiding the UE from using the beam sweeping to determine an uplink beam repeatedly and effectively shortening beam control time.

However, if a relative position between the base station and the UE antenna module changes at different moments due to factors such as high-speed movement of the UE, a beam pair determined by the above beam correspondence method may not achieve the best transmission effect, thereby affecting the transmission performance.

### SUMMARY

In order to overcome the problems in the related art, the embodiments of the present disclosure provide a beam correspondence method and apparatus, user equipment, and a base station to ensure the transmission performance of the system using high-frequency beams for information transmission.

According to a first aspect of the embodiments of the present disclosure, a beam correspondence method is provided, which is applied to user equipment, and the method includes:

determining sweeping configuration information for a beam correspondence state, wherein the sweeping configuration information indicates that in the beam correspondence state, the user equipment performs a beam sweeping to re-determine a best matching beam pair when a relative position between an antenna module of the user equipment and the base station changes.

in the beam correspondence state, triggering the beam sweeping according to the sweeping configuration information to obtain a beam correspondence result, wherein the beam sweeping is performed to re-determine the best matching beam pair;

sending the beam correspondence result to the base station, so that the base station determines a transmission beam with reference to the beam correspondence result.

Optionally, determining the sweeping configuration information for the beam correspondence state includes:

receiving the sweeping configuration information issued by the base station.

Optionally, the sweeping configuration information at least includes: trigger configuration information used to instruct the user equipment to trigger the beam sweeping when a preset trigger condition is met;

in the beam correspondence state, triggering the beam sweeping according to the sweeping configuration information to obtain a beam correspondence result includes:

in the beam correspondence state, determining whether the beam sweeping is to be triggered currently according to the trigger configuration information;

in response to that the beam sweeping is to be performed, determining beam sweeping range information;

performing the beam sweeping according to the beam sweeping range information to obtain the beam correspondence result.

Optionally, the trigger configuration information includes a preset sweeping trigger threshold value;

determining whether the beam sweeping is to be triggered currently according to the trigger configuration information includes:

determining a displacement reference value at a current timing relative to a most recent information transmission, wherein the displacement reference value indicates a relative displacement between the base station and an antenna module of the user equipment;

comparing the displacement reference value with the preset sweeping trigger threshold to determine whether the beam sweeping is to be triggered currently.

Optionally, the trigger configuration information further includes: preset period duration information;

determining the displacement reference value at the current timing relative to the most recent information transmission includes:

after the most recent information transmission is completed, in response to detecting that a position of the antenna module relative to the base station has changed, determining the displacement reference value according to the preset period duration information.

Optionally, the displacement reference value includes a current moving speed of the UE relative to the base station; the preset sweeping trigger threshold is a preset speed threshold;

comparing the displacement reference value with the preset sweeping trigger threshold to determine whether the beam sweeping is to be triggered currently includes:

determining whether the current moving speed is greater than or equal to the preset speed threshold;

in response to the current moving speed being greater than or equal to the preset speed threshold, determining that the beam sweeping is to be triggered currently;

in response to the current moving speed being less than the preset speed threshold, determining that the beam sweeping does not need to be triggered currently.

Optionally, determining the beam sweeping range information includes:

determining the beam sweeping range information according to preset sweeping range configuration information; or,

obtaining the beam sweeping range information issued by the base station.

Optionally, determining the beam sweeping range information according to the preset sweeping range configuration information includes:

determining all beams as to-be-swept beams according to the preset sweeping range configuration information; or

determining part of the beams as the to-be-swept beams according to the preset sweeping range configuration information and original matching beam pair information;

wherein the original matching beam pair information is information on a best matching beam pair determined in the most recent information transmission.

Optionally, the preset sweeping range configuration information includes: a correspondence between the preset displacement deviation value and first preset sweeping range information;

determining part of the beams as the to-be-swept beams according to the preset sweeping range configuration information and the original matching beam pair information includes:

determining a difference between the displacement reference value and the preset sweeping threshold to obtain the current displacement deviation value;

determining the first preset sweeping range information corresponding to the current displacement deviation value according to the current displacement deviation value and the preset sweeping range configuration information, so as to obtain target sweeping range information;

determining the to-be-swept beams according to the target sweeping range information and the original matching beam pair information.

Optionally, the first preset sweeping range information includes: first preset coverage angle information; the target sweeping range information includes: a first target coverage angle which is the first preset coverage angle information corresponding to the current displacement deviation value;

determining the to-be-swept beams according to the target sweeping range information and the original matching beam pair information includes:

determining a first number of deviation beams according to the beam tracking capability information of the user equipment and the first target coverage angle;

determining the to-be-swept beams according to the original matching beam pair information and the first number of deviation beams.

Optionally, the preset sweeping range configuration information includes:

second preset sweeping range information;

determining part of the beams as the to-be-swept beams according to the preset sweeping range configuration information and the original matching beam pair information includes:

determining the second number of deviation beams according to the second preset sweeping range information;

determining the to-be-swept beams according to the original matching beam pair information and the second number of deviation beams.

Optionally, the second preset sweeping range information includes: second preset coverage angle information;

determining the second number of deviation beams according to the second preset sweeping range information includes:

determining the second number of deviation beams according to the beam tracking capability information of the user equipment and the second preset coverage angle information.

Optionally, the second preset sweeping range information is preset sweeping range information determined by the base station according to a maximum displacement reference value of the user equipment.

Optionally, obtaining the beam sweeping range information issued by the base station includes:

sending range configuration request information to the base station, where the range configuration request information is used to request the base station to configure a beam sweeping range for the user equipment;

receiving the beam sweeping range information sent by the base station.

Optionally, performing the beam sweeping according to the beam sweeping range information to obtain the beam correspondence result includes:

determining reference signal configuration information of the to-be-swept beams.

performing the beam sweeping according to the reference signal configuration information and the to-be-swept beams to obtain the beam correspondence result.

Optionally, determining the reference signal configuration information of the to-be-swept beams includes: receiving the reference signal configuration information for the to-be-swept beams sent by the base station.

According to a second aspect of the embodiments of the present disclosure, a beam correspondence method is provided, which is applied to a base station, and the method includes:

receiving a beam correspondence result sent by user equipment, wherein the beam correspondence result indicates information on a best matching beam pair re-determined after the user equipment performs a beam sweeping in a beam correspondence state;

determining a transmission beam used for transmitting information between the base station and the user equipment according to the beam correspondence result.

Optionally, before receiving the beam correspondence result sent by the user equipment, the method further includes:

sending sweeping configuration information to the user equipment under a preset trigger condition;

the sweeping configuration information indicates that in the beam correspondence state, performs the beam sweeping to re-determine a best matching beam pair when a relative position between an antenna module of the user equipment and the base station changes.

the preset trigger condition includes at least one of the following:

when detecting that the user equipment is connected to network;

when detecting that the user equipment initiates the millimeter wave module;

when detecting that the user equipment initiates the antenna module of a millimeter wave frequency band.

Optionally, before receiving the beam correspondence result sent by the user equipment, the method further includes:

receiving range configuration request information sent by the user equipment, wherein the range configuration request information is used to request the base station to configure a beam sweeping range for the user equipment;

determining beam sweeping range information according to the range configuration request information;

sending the beam sweeping range information to the user equipment.

Optionally, determining the beam sweeping range information includes:

determining all beams as to-be-swept beams according to preset sweeping range configuration information; or

determining part of the beams as the to-be-swept beams according to the preset sweeping range configuration information and original matching beam pair information; wherein the original matching beam pair information is information on a best matching beam pair determined in the most recent information transmission.

Optionally, the range configuration request information includes: a displacement reference value of the user equipment which indicates a relative displacement between the antenna module of the user equipment and the base station;

the preset sweeping range configuration information includes: a correspondence between the preset displacement deviation value and first preset sweeping range information;

determining part of the beams as the to-be-swept beams according to the preset sweeping range configuration information and the original matching beam pair information includes:

determining a difference between the displacement reference value and a preset sweeping threshold to obtain a current displacement deviation value;

determining the first preset sweeping range information corresponding to the current displacement deviation value according to the current displacement deviation value and the preset sweeping range configuration information, so as to obtain target sweeping range information;

determining the to-be-swept beams according to the target sweeping range information and the original matching beam pair information.

Optionally, the first preset sweeping range information includes: first preset coverage angle information; the target sweeping range information includes: a first target coverage angle which is the first preset coverage angle information corresponding to the current displacement deviation value;

determining the to-be-swept beams according to the target sweeping range information and the original matching beam pair information includes:

determining a first number of deviation beams according to the beam tracking capability information of the user equipment and the first target coverage angle;

determining the to-be-swept beams according to the original matching beam pair information and the first number of deviation beams.

Optionally, the preset sweeping range configuration information includes:

second preset sweeping range information;

determining part of the beams as the to-be-swept beams according to the preset sweeping range configuration information and the original matching beam pair information includes:

determining the second number of deviation beams according to the second preset sweeping range information;

determining the to-be-swept beams according to the original matching beam pair information and the second number of deviation beams.

Optionally, the second preset range information includes: second preset coverage angle information:

determining the second number of deviation beams according to the second preset sweeping range information includes:

determining the second number of deviation beams according to the beam tracking capability information of the user equipment and the second preset coverage angle information.

Optionally, the second preset sweeping range information is preset sweeping range information determined by the base station according to a maximum displacement reference value of the user equipment.

Optionally, the range configuration request information includes: beam tracking capability of the user equipment; or

before receiving the range configuration request sent by the user equipment, the method further includes:

obtaining the beam tracking capability information of the user equipment.

Optionally, the method further includes:

sending a transmission beam determination result to the user equipment, so that the user equipment determines whether to use a newly determined best matching beam pair to transmit information.

According to a third aspect of the embodiments of the present disclosure, a beam correspondence apparatus is provided, which is applied to user equipment, and the apparatus includes:

a configuration information determining module, configured to determine sweeping configuration information for a beam correspondence state, wherein the sweeping configuration information indicates that in the beam correspondence state, the user equipment performs a beam sweeping to re-determine a best matching beam pair when a relative position between an antenna module of the user equipment and the base station changes.

a sweeping module, configured to, in the beam correspondence state, trigger the beam sweeping according to the sweeping configuration information to obtain a beam correspondence result, wherein the beam sweeping is performed to re-determine the best matching beam pair;

a sending module, configured to sending the beam correspondence result to the base station, so that the base station determines a transmission beam with reference to the beam correspondence result.

Optionally, the configuration information determining module is configured to receive the sweeping configuration information issued by the base station.

Optionally, the sweeping configuration information at least includes: trigger configuration information used to instruct the user equipment to trigger the beam sweeping when a preset trigger condition is met;

the sweeping module includes:

a trigger determining sub-module, configured to, in the beam correspondence state, determine whether the beam sweeping is to be triggered currently according to the trigger configuration information;

a sweeping range determining sub-module, configured to in response to that the beam sweeping is to be performed, determine beam sweeping range information;

a sweeping sub-module, configured to perform the beam sweeping according to the beam sweeping range information to obtain the beam correspondence result.

Optionally, the trigger configuration information includes a preset sweeping trigger threshold;

the trigger determining sub-module includes:

a position variance determining unit, configured to determine a displacement reference value at a current timing relative to a most recent information transmission, wherein the displacement reference value indicates a relative displacement between the base station and an antenna module of the user equipment;

a trigger determining unit, configured to compare the displacement reference value with the preset sweeping trigger threshold to determine whether the beam sweeping is to be triggered currently.

Optionally, the trigger configuration information further includes: preset period duration information;

the position variance determining unit is configured to, after the most recent information transmission is completed, in response to detecting that a position of the antenna module relative to the base station has changed, determine the displacement reference value according to the preset period duration information.

Optionally, the displacement reference value includes a current moving speed of the UE relative to the base station; the preset sweeping trigger threshold is a preset speed threshold;

the trigger determining unit includes:

a speed determining sub-unit, configured to determine whether the current moving speed is greater than or equal to the preset speed threshold;

a first determining sub-unit, configured to in response to the current moving speed being greater than or equal to the preset speed threshold, determine that the beam sweeping is to be triggered currently;

a second determining sub-unit, configured to in response to the current moving speed being less than the preset speed threshold, determining that the beam sweeping does not need to be triggered currently.

Optionally, the sweeping range determining sub-module includes any of the following units:

a first range determining unit, configured to determine the beam sweeping range information according to preset sweeping range configuration information;

a second range determining unit, obtain the beam sweeping range information issued by the base station.

Optionally, the first range determining unit includes any of the following sub-units:

a first beam determining sub-unit, configured to determine all beams as to-be-swept beams according to the preset sweeping range configuration information;

a second beam determining sub-unit, configured to determine part of the beams as the to-be-swept beams according to the preset sweeping range configuration information and original matching beam pair information; wherein the original matching beam pair information is information on a best matching beam pair determined in the most recent information transmission.

Optionally, the preset sweeping range configuration information includes: a correspondence between the preset displacement deviation value and first preset sweeping range information;

the second beam determining sub-unit includes:

a displacement deviation determination module, configured to determine a difference between the displacement reference value and the preset sweeping threshold to obtain the current displacement deviation value;

a target range determining module, configured to determine the first preset sweeping range information corresponding to the current displacement deviation value according to the current displacement deviation value and the preset sweeping range configuration information, so as to obtain target sweeping range information;

a first sweeping beam determining module, configured to determine the to-be-swept beams according to the target sweeping range information and the original matching beam pair information.

Optionally, the first preset sweeping range information includes: first preset coverage angle information; the target sweeping range information includes: a first target coverage angle which is the first preset coverage angle information corresponding to the current displacement deviation value;

the first sweeping beam determining module includes:

a first deviated beam determining sub-module, configured to determine a first number of deviation beams according to the beam tracking capability information of the user equipment and the first target coverage angle;

a first beam determining sub-module, configured to determine the to-be-swept beams according to the original matching beam pair information and the first number of deviation beams.

Optionally, the preset sweeping range configuration information includes:

second preset sweeping range information;

the second beam determining sub-unit includes:

a deviated beam determining module, configured to determine the second number of deviation beams according to the second preset sweeping range information;

a second sweeping beam determining module, configured to determine the to-be-swept beams according to the original matching beam pair information and the second number of deviation beams.

Optionally, the second preset sweeping range information includes: second preset coverage angle information;

the deviated beam determining module is configured to determine the second number of deviation beams according to the beam tracking capability information of the user equipment and the second preset coverage angle information.

Optionally, the second preset sweeping range information is preset sweeping range information determined by the base station according to a maximum displacement reference value of the user equipment.

Optionally, the second range determining unit includes:

a range requesting sub-unit, configured to send range configuration request information to the base station, where the range configuration request information is used to request the base station to configure a beam sweeping range for the user equipment;

a range information receiving sub-unit, configured to receive the beam sweeping range information sent by the base station.

Optionally, the sweeping sub-module includes:

a reference signal determining unit, configured to determine reference signal configuration information of the to-be-swept beams;

a beam sweeping unit, configured to perform the beam sweeping according to the reference signal configuration information and the to-be-swept beams to obtain the beam correspondence result.

Optionally, the reference signal determining unit is configured to receive the reference signal configuration information for the to-be-swept beams sent by the base station.

According to a fourth aspect of the embodiments of the present disclosure, a beam correspondence apparatus is provided, which is applied to a base station, and the apparatus includes:

a receiving module, configured to receive a beam correspondence result sent by user equipment, wherein the beam correspondence result indicates information on a best matching beam pair re-determined after the user equipment performs a beam sweeping in a beam correspondence state;

a beam determining module, configured to determining a transmission beam used for transmitting information between the base station and the user equipment according to the beam correspondence result.

Optionally, the apparatus further includes:

a configuration information sending module, configured to send sweeping configuration information to the user equipment under a preset trigger condition;

the sweeping configuration information indicates that in the beam correspondence state, performs the beam sweeping to re-determine a best matching beam pair when a relative position between an antenna module of the user equipment and the base station changes.

the preset trigger condition includes at least one of the following:

when detecting that the user equipment is connected to network;

when detecting that the user equipment initiates the millimeter wave module;

when detecting that the user equipment initiates the antenna module of a millimeter wave frequency band.

Optionally, the apparatus further includes:

a request receiving module, configured to receive range configuration request information sent by the user equipment, wherein the range configuration request information is used to request the base station to configure a beam sweeping range for the user equipment;

a sweeping range determining module, configured to determine beam sweeping range information according to the range configuration request information;

a sweeping range sending module, configured to send the beam sweeping range information to the user equipment.

Optionally, the sweeping range determining module includes any of the following sub-modules:

a first sweeping beam determining sub-module, configured to determine all beams as to-be-swept beams according to preset sweeping range configuration information;

a second sweeping beam determining sub-module, configured to determine part of the beams as the to-be-swept beams according to the preset sweeping range configuration information and original matching beam pair information; wherein the original matching beam pair information is information on a best matching beam pair determined in the most recent information transmission.

Optionally, the range configuration request information includes: a displacement reference value of the user equipment which indicates a relative displacement between the antenna module of the user equipment and the base station;

the preset sweeping range configuration information includes: a correspondence between the preset displacement deviation value and first preset sweeping range information;

the second sweeping beam determining sub-module includes:

a displacement deviation determining unit, configured to determine a difference between the displacement reference value and a preset sweeping threshold to obtain a current displacement deviation value;

a target range determining unit, configured to determine the first preset sweeping range information corresponding to the current displacement deviation value according to the current displacement deviation value and preset sweeping range configuration information, so as to obtain target sweeping range information; and

a first sweeping beam determining unit, configured to determine the to-be-swept beams according to the target sweeping range information and the original matching beam pair information.

Optionally, the first preset sweeping range information includes: first preset coverage angle information; the target sweeping range information includes: a first target coverage angle which is the first preset coverage angle information corresponding to the current displacement deviation value;

the first sweeping beam determining unit includes:

a first deviation beam determining sub-unit, configured to determine a first number of deviation beams according to the beam tracking capability information of the user equipment and the first target coverage angle;

a first beam determining sub-unit, configured to determine the to-be-swept beams according to original matching beam pair information and the first number of deviation beams.

Optionally, the preset sweeping range configuration information includes:

second preset sweeping range information;

the second sweeping beam determining sub-module includes:

a deviated beam determining unit, configured to determine the second number of deviation beams according to the second preset sweeping range information;

a second sweeping beam determining unit, configured to determine the to-be-swept beams according to the original matching beam pair information and the second number of deviation beams.

Optionally, the second preset range information includes: second preset coverage angle information:

the deviated beam determining unit is configured to determine the second number of deviation beams according to the beam tracking capability information of the user equipment and the second preset coverage angle information.

Optionally, the second preset sweeping range information is preset sweeping range information determined by the base station according to a maximum displacement reference value of the user equipment.

Optionally, the range configuration request information includes: beam tracking capability of the user equipment; or

the apparatus further includes:

a tracking capability information obtaining module, configured to obtain the beam tracking capability information of the user equipment.

In an embodiment of the present disclosure, the device further includes:

a feedback module, configured to send a transmission beam determination result to the user equipment, so that the user equipment determines whether to use a newly determined best matching beam pair to transmit information.

According to a fifth aspect of the embodiments of the present disclosure, there is provided a non-transitory computer-readable storage medium having computer instructions stored thereon, which, in a case that the computer instructions are executed by a processor, implement the steps of any of the methods according to the first aspect.

According to a sixth aspect of the embodiments of the present disclosure, there is provided a non-transitory computer-readable storage medium having computer instructions stored thereon, which, in a case that the computer instructions are executed by a processor, implement the steps of any of the methods according to the second aspect.

According to the seventh aspect of the examples of the present disclosure, there is provided user equipment, including:

a processor, and

memory for storing instructions executable by the processor;

wherein the processor is configured to:

determine sweeping configuration information for a beam correspondence state, wherein the sweeping configuration information indicates that in the beam correspondence state, the user equipment performs a beam sweeping to re-determine a best matching beam pair when a relative position between an antenna module of the user equipment and the base station changes.

in the beam correspondence state, trigger the beam sweeping according to the sweeping configuration information to obtain a beam correspondence result, wherein the beam sweeping is performed to re-determine the best matching beam pair;

send the beam correspondence result to the base station, so that the base station determines a transmission beam with reference to the beam correspondence result.

According to an eighth aspect of the embodiments of the present disclosure, there is provided a base station, including:

a processor, and

memory for storing instructions executable by the processor;

wherein the processor is configured to:

receive a beam correspondence result sent by user equipment, wherein the beam correspondence result indicates information on a best matching beam pair re-determined after the user equipment performs a beam sweeping in a beam correspondence state;

determine a transmission beam used for transmitting information between the base station and the user equipment according to the beam correspondence result. The technical solutions provided by an example of the present disclosure may include the following beneficial effects.

In the present disclosure, when the relative position of the UE with the base station changes in the beam correspondence state, the beam sweeping can be triggered based on the sweeping configuration information to re-determine the information on a best matching beam pair at the current timing, so as to prepare for subsequent information transmission, and ensure that when high-frequency beams such as millimeter wave band beams are used to transmit information between the UE and the base station, the best matched beam pairs can be used to transmit information, and the information transmission performance of the system in the high-frequency band can be improved.

It is understood that the above general descriptions and subsequent detailed descriptions are merely illustrative and explanatory and shall not constitute limitations to the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a schematic diagram illustrating an application scenario for beam correspondence according to an exemplary embodiment of present disclosure.

FIG. 2 is a flowchart of a beam correspondence method according to an example of the present disclosure.

FIG. 3 is a flowchart of another beam correspondence method according to an example of the present disclosure.

FIG. 4 is a flowchart of another beam correspondence method according to an example of the present disclosure.

FIG. 5 is a flowchart of another beam correspondence method according to an example of the present disclosure.

FIG. 6 is a flowchart of another beam correspondence method according to an example of the present disclosure.

FIG. 7 is a flowchart of another beam correspondence method according to an example of the present disclosure.

FIG. 8 is a flowchart of another beam correspondence method according to an example of the present disclosure.

FIG. 9 is a flowchart of another beam correspondence method according to an example of the present disclosure.

FIG. 10 is a flowchart of another beam correspondence method according to an example of the present disclosure.

FIG. 11 is a flowchart of a beam correspondence method according to an example of the present disclosure.

FIG. 12 is a flowchart of another beam correspondence method according to an example of the present disclosure.

FIG. 13 is a flowchart of another beam correspondence method according to an example of the present disclosure.

FIG. 14 is a flowchart of another beam correspondence method according to an example of the present disclosure.

FIG. 15 is a flowchart of another beam correspondence method according to an example of the present disclosure.

FIG. 16 is a flowchart of another beam correspondence method according to an example of the present disclosure.

FIG. 17 is a flowchart of another beam correspondence method according to an example of the present disclosure.

FIG. 18 is a block diagram of a beam correspondence apparatus according to an example of the present disclosure.

FIG. 19 is a block diagram of another beam correspondence apparatus according to an example of the present disclosure.

FIG. 20 is a block diagram of another beam correspondence apparatus according to an example of the present disclosure.

FIG. 21 is a block diagram of another beam correspondence apparatus according to an example of the present disclosure.

FIG. 22 is a block diagram of another beam correspondence apparatus according to an example of the present disclosure.

FIG. 23 is a block diagram of another beam correspondence apparatus according to an example of the present disclosure.

FIG. 24 is a block diagram of another beam correspondence apparatus according to an example of the present disclosure.

FIG. 25 is a block diagram of another beam correspondence apparatus according to an example of the present disclosure.

FIG. 26 is a block diagram of another beam correspondence apparatus according to an example of the present disclosure.

FIG. 27 is a block diagram of a beam correspondence apparatus according to an example of the present disclosure.

FIG. 28 is a block diagram of another beam correspondence apparatus according to an example of the present disclosure.

FIG. 29 is a block diagram of another beam correspondence apparatus according to an example of the present disclosure.

FIG. 30 is a block diagram of another beam correspondence apparatus according to an example of the present disclosure.

FIG. 31 is a block diagram of another beam correspondence apparatus according to an example of the present disclosure.

FIG. 32 is a block diagram of another beam correspondence apparatus according to an example of the present disclosure.

FIG. 33 is a block diagram of another beam correspondence apparatus according to an example of the present disclosure.

FIG. 34 is a block diagram of another beam correspondence apparatus according to an example of the present disclosure.

FIG. 35 is a block diagram of another beam correspondence apparatus according to an example of the present disclosure.

FIG. 36 is a schematic structural diagram of user equipment according to an example of the present disclosure.

FIG. 37 is a schematic structural diagram of a base station according to an example of the present disclosure.

### DETAILED DESCRIPTION

Embodiments will be described in detail herein with the examples thereof expressed in the drawings. When the following descriptions involve the drawings, like numerals in different drawings represent like or similar elements unless stated otherwise. The embodiments described in the following examples do not represent all embodiments consistent with the present disclosure. Rather, they are merely examples of apparatuses and methods consistent with some aspects of the present disclosure as detailed in the appended claims.

The term used in the present disclosure is for the purpose of describing particular examples only and is not intended to limit the present disclosure. As used in this disclosure and the appended claims, the singular forms “a”, “an” and “the” are intended to include the plural forms as well, unless the context clearly indicates otherwise. It should also be understood that the term “and/or” as used herein refers to and includes any and all possible combinations of one or more of the associated listed items.

It shall be understood that, although the terms “first,” “second,” “third,” and the like may be used herein to describe various information, the information should not be limited by these terms. These terms are only used to distinguish one category of information from another. For example, without departing from the scope of the present disclosure, first information may be referred as second information; and similarly, second information may also be referred as first information. As used herein, the term “if” may be interpreted as “when” or “upon” or “in response to determining” depending on the context.

The entities performing methods involved the present disclosure may include: base stations and user equipment (UE) in mobile communication networks such as 4G LTE (Long Term Evolution), LTE-NR interworking, and 5G NR, where the base station may be a base station or a sub-base station provided with a large-scale antenna array, and so on. The UE may be a user terminal, a user node, a mobile terminal, a tablet computer, etc. In the specific implementation process, the base station and the user equipment are independent of each other, and at the same time are connected to each other, so as to implement the technical solutions provided by the present disclosure together.

An application scenario of the present disclosure is that, during the most recent information transmission, such as at time T0, the UE and the base station have determined the information on a best matching beam pair at the time T0 according to the beam correspondence (BC) technology. The information on a best matching beam pair indicates which beam transmitted by the UE at time T0 matches which beam transmitted by the base station, and can carry information transmission between the base station and the UE with the best transmission performance.

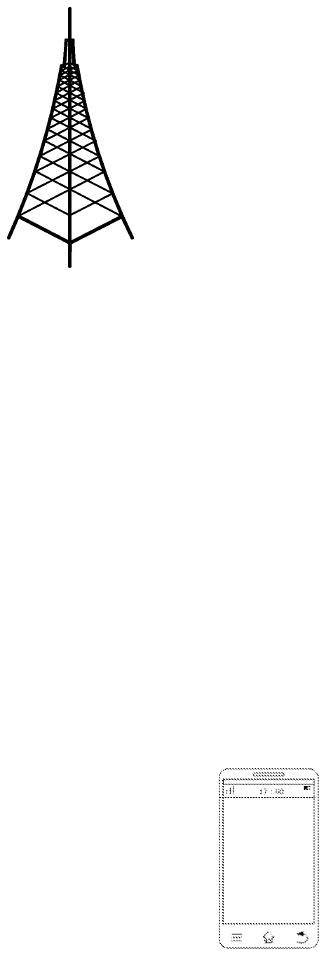

FIG. 1 is a schematic diagram illustrating an application scenario for beam correspondence according to an exemplary embodiment of present disclosure. Assuming that the base station uses beam 2 to transmit downlink data to UE1, UE1 can determine according to the beam correspondence technology that if the uplink information is to be transmitted to the base station, a beam c corresponding to beam 2 can be used for uplink transmission. That is, the best matching beam pair according to the completed downlink transmission determined by UE1 is: beam2-beam c.

In this disclosure, the uplink transmission refers to sending information from the UE to the base station; the downlink transmission refers to sending information from the base station to the UE. The uplink transmission beam refers to a high-frequency beam carrying uplink information transmission, which is transmitted by the UE, such as beam a, beam b, beam c, and beam d in the example shown in FIG. 1. The downlink transmission beam refers to a high-frequency beam carrying downlink information transmission, which is transmitted by the base station, such as beam 1, beam 2, beam 3, beam 4, and beam 5 in the example shown in FIG. 1.

According to related technologies, when the relative position between the antenna module of UE1 and the base station remains unchanged, after T0, if UE1 wants to send uplink information to the base station, beam c can be used directly for uplink transmission. However, if the relative position between the antenna module of UE and the base station is changed, for example, in an application scenario of V2X (Vehicle-to-Everything) of the 5G NR system, when a vehicle is driving, a vehicle-mounted equipment communicated with the base station may move in real time relative to the base station. The equipment may move a distance of several meters in a short period of time, such as 1s, resulting in a change in the relative position between the antenna module of the vehicle-mounted equipment and the base station. According to the transmission characteristics of high-frequency beam, the best matching beam pair determined in the last is may not be able to ensure the best transmission performance at the current timing. Therefore, the best matching beam pair is to be re-determined for the current timing to ensure subsequent information transmission performance.

Based on the above, the present disclosure provides a beam correspondence method, which determines the best matching beam pair at the current timing in a beam corresponded state, that is, when the best matching beam pair at the previous moment is known.

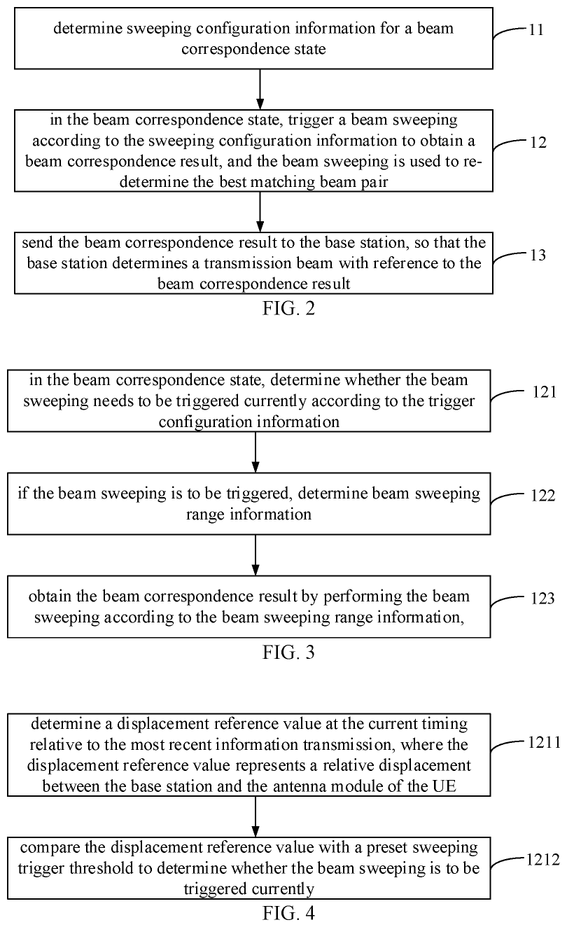

Referring to FIG. 2, a flowchart illustrating a beam correspondence method according to an example, which is applicable to a UE and includes the following steps.

At step 11, sweeping configuration information for a beam correspondence state is determined, and the sweeping configuration information indicates that in the beam correspondence state, the UE performs beam sweeping to re-determine the best matching beam pair when a relative position between an antenna module of the user equipment and the base station changes.

As described above, for the UE, being in the beam correspondence state means that the UE has determined that there is a matching beam pair according to the beam correspondence technology.

In the present disclosure, before the UE performs beam sweeping for the beam correspondence state to re-determine the best matching beam pair, it can determine the sweeping configuration information for the beam correspondence state, so that when the best matching beam is to be re-determined in the beam correspondence state, the sweeping configuration information can be used to perform the beam sweeping, thereby re-determining the best matching beam pair.

Regarding the manner in which the UE determines the sweeping configuration information, in an embodiment of the present disclosure, the sweeping configuration information may be pre-configured information in the UE, and the UE may directly determine the sweeping configuration information.

The pre-configured information refers to configuration information that is directly set in the UE according to a system agreement without receiving the signaling issued by the base station.

In another embodiment of the present disclosure, the foregoing sweeping configuration information may be configuration information sent by the base station to the UE through signaling. Then, the above step 11 may specifically be: receiving the sweeping configuration information issued by the base station.

In the present disclosure, the base station may send sweeping configuration information to the base station under at least one of the following trigger conditions.

Condition 1: When the base station detects that the UE is connected to the network;

Condition 2: When the base station detects that the UE has initiated a millimeter wave communication module;

Condition 3: When the base station detects that the UE has initiated a millimeter wave frequency band for communication.

In the present disclosure, the base station may use broadcast signaling, upper layer signaling or physical layer signaling to send the sweeping configuration information to the UE, where the upper layer signaling may be RRC (Radio Resource Control) signaling, MAC (Medium Access Control) CE (Control Element) signaling etc..

In the present disclosure, the sweeping configuration information includes at least: trigger configuration information; wherein the trigger configuration information is used to instruct the user equipment to trigger the beam sweeping when a preset trigger condition is met. In other words, the sweeping trigger configuration information is used to instruct the UE to perform the beam sweeping in the beam correspondence state to re-determine the trigger condition information of the best matching beam pair.

At step 12, in the beam correspondence state, a beam sweeping is triggered according to the sweeping configuration information to obtain a beam correspondence result, and the beam sweeping is performed to re-determine the best matching beam pair;

Correspondingly, the beam correspondence result indicates the relevant information of the best matching beam pair re-determined after the user equipment performs the beam sweeping.

FIG. 3 is a flowchart of another beam correspondence method according to an example of the present disclosure, the step 12 may include:

At step 121, in the beam correspondence state, whether the beam sweeping is to be triggered currently is determined according to the trigger configuration information;

In an embodiment of the present disclosure, the trigger configuration information may include preset trigger condition information instructing the UE to perform beam sweeping in the beam correspondence state to re-determine the best matching beam pair. For example, when the moving speed of the UE is greater than a preset speed threshold, the beam sweeping is triggered.

In another embodiment of the present disclosure, when the system has agreed upon a sweeping trigger determination rule, the trigger configuration information may also only include a preset sweeping trigger threshold, for example, a preset speed threshold. Correspondingly, the sweeping trigger determination rule agreed by the system may be: when the moving speed of the UE is greater than the preset speed threshold, the beam sweeping is triggered.

Correspondingly, FIG. 4 is a flowchart of another beam correspondence method according to an example of the present disclosure. The step 121 may include:

At step 1211, a displacement reference value at a current timing relative to a most recent information transmission is determined, where the displacement reference value represents a relative displacement between the base station and the antenna module of the UE;

As in the above example, suppose that the timing of the most recent information transmission is T0, and the current timing is T1 after T0 for a certain period of time, such as 2s. The reference value is a value indicating a change in a relative position between the base station and the antenna module of the UE.

In an embodiment of the present disclosure, the displacement reference value may be a value generated because the UE has a translational motion relative to the base station. In an embodiment, the displacement reference value may be expressed as a speed change value of the UE, and the speed change value may be determined by data output by a built-in acceleration sensor, a speed sensor, and a position sensor such as GPS in the UE.

In another embodiment of the present disclosure, the displacement reference value may also be a value determined based on a posture change of the UE relative to the base station. In an embodiment, the displacement reference value may be expressed as a rotation angle, a rotation angular velocity, etc., which represent a posture change of the UE, and may be measured by a gyroscope sensor built in the UE.

In another embodiment of the present disclosure, the displacement reference value may also be a value comprehensively determined in combination with the speed change and attitude change of the UE. The present disclosure does not limit the specific expression form of the displacement reference value.

Regarding the determination method of the displacement reference value, the UE may calculate the relative position change according to a preset time length, thereby determining the displacement reference value, so as to avoid triggering the beam sweeping when the position change of the UE relative to the base station is a transient change and causing redetermining the best match beam pair frequently and mistakenly. The transient change refers to that the relative position between the antenna module of the UE and the base station changes instantly and then restores to the original state; in this case, there is no need to re-determine the best matching beam pair.

In another embodiment of the present disclosure, the trigger configuration information may further include: preset period duration information; the preset period duration information may be periodical preset time window length information agreed by the system or configured by the base station.

Correspondingly, step 1211 may include:

After the most recent information transmission is completed, when a position change of the antenna module is detected, the displacement reference value is determined according to the preset period duration information.

As in the above example, after the UE detects a change in its moving speed and/or posture after T0, it can use the preset period duration information, such as 50 ms, and use a time integration method or an averaging method to determine a displacement reference value every 50 ms.

In the embodiments of the present disclosure, the preset period duration information of the real-time configuration of the base station or the system configuration is used to determine the displacement reference value, which can more accurately determine whether the UE needs to trigger the beam sweeping, and avoid frequently and mistakenly triggering the beam sweeping due to transient changes in relative positions, thereby saving the UE power consumption.

At step 1212, the displacement reference value is compared with a preset sweeping trigger threshold to determine whether the beam sweeping is to be triggered currently.

In an embodiment of the present disclosure, the displacement reference value may be the current moving speed of the UE, and the preset sweeping trigger threshold may be a preset speed threshold.

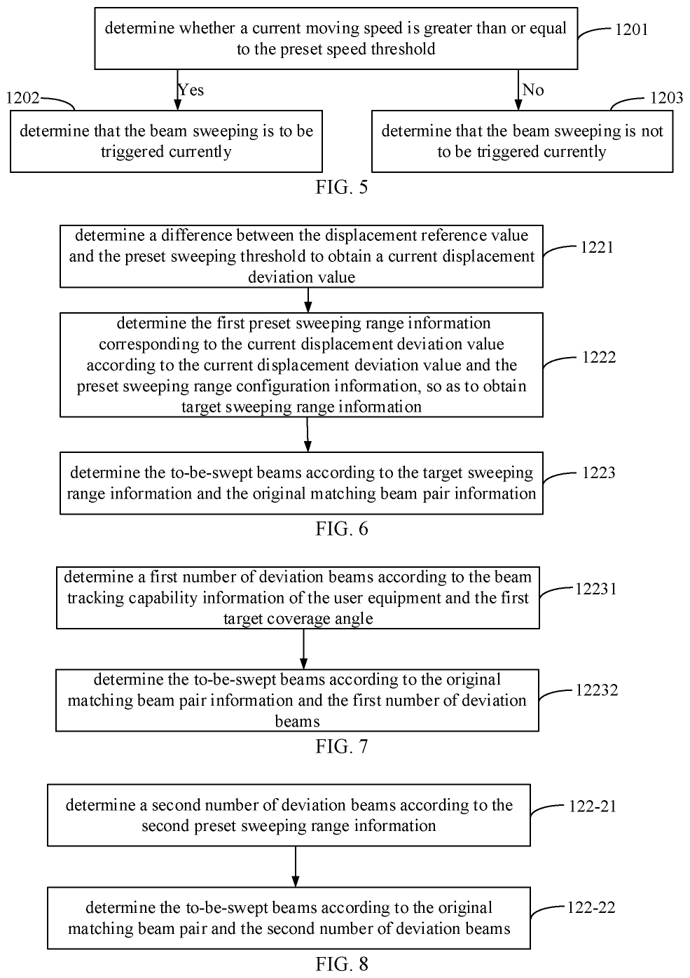

Correspondingly, FIG. 5 is a flowchart of another beam correspondence method according to an example of the present disclosure. The step 1212 may include:

At step 1201, it is determined whether a current moving speed is greater than or equal to the preset speed threshold.

At step 1202, if the current moving speed is greater than or equal to the preset speed threshold, it is determined that the beam sweeping is to be triggered currently;

At step 1203, if the current moving speed is less than the preset speed threshold, it is determined that the beam sweeping does not need to be triggered currently.

The foregoing embodiment may be applicable to the trigger configuration scenario of the V2X system, and it is determined whether the beam sweeping is to be triggered according to the moving speed of the UE, so as to determine whether the best matching beam pair is to be re-determined currently.

At step 122, if the beam sweeping is to be triggered, beam sweeping range information is determined;

The beam sweeping range information indicates in which range the UE performs the beam sweeping.

In the case that the UE determines that the beam sweeping is to be triggered currently, the implementation of the step 122 may include two situations according to the execution subject of determining the beam sweeping range information:

Under the first situation, the UE determines the beam sweeping range information according to preset sweeping range configuration information;

Regarding obtaining method of the preset sweeping range configuration information, in an embodiment, the preset sweeping range configuration information may be pre-configured information included in the factory configuration of the UE. For example, after the producer of the UE determining the preset sweeping range configuration information according to the sweeping configuration agreed by the system and in combination with the hardware performance of the UE, the preset sweeping range configuration information is set in the UE in a fixed way.

In an embodiment of the present disclosure, the UE may obtain the preset sweeping range configuration information from the sweeping configuration information. That is, the sweeping configuration information determined in step 11 above may further include: the preset sweeping range configuration information.

According to the different content indicated by the preset sweeping range configuration information, the UE can determine the beam sweeping range information in the following manners:

Manner 1: the preset sweeping range configuration information instructs the UE to perform full range beam sweeping when determining that the beam sweeping is to be performed.

Then, the step 122 may be specifically step 122-1, including: determining all beams as to-be-swept beams according to the preset sweeping range configuration information.

As shown in the example in FIG. 1 above, all beams are used as to-be-swept beams, that is, each beam of beam a, beam b, beam c, and beam d is respectively matched with the beams 1 to 5 transmitted by the base station, and a total of 20 beam correspondence measurements are performed to determine the best matching beam pair.

Manner 2: the preset sweeping range configuration information instructs the UE to perform partial beam sweeping according to a preset beam deviation range when determining that the beam sweeping is to be performed.

Correspondingly, the step 122 may be specifically step 122-2, including: determining a part of the beams as the to-be-swept beams according to the preset sweeping range configuration information and the original matching beam pair information.

According to the different content of the preset sweeping range configuration information, the step 122-2 may also include two implementation manners:

In the first implementation manner, the UE dynamically determines the to-be-swept beams according to the displacement deviation value determined in real time.

In an embodiment of the present disclosure, the preset sweeping range configuration information includes: a correspondence between a preset displacement deviation value and first preset sweeping range information.

The preset displacement deviation value corresponds to the displacement reference value, for example, it may be a value such as a speed deviation value, a rotation angle, and the like. The first preset sweeping range information may be a preset number of deviation beams or may be preset coverage angle information.

FIG. 6 is a flowchart of another beam correspondence method according to an example of the present disclosure. The step 122-2 may include:

At step 1221, a difference between the displacement reference value and the preset sweeping threshold is determined to obtain a current displacement deviation value;

In the present disclosure, the current displacement deviation value indicates how much the relative position between the UE and the base station has changed at the current moment since the last transmission is completed. It can be predicted that the larger the current displacement deviation value, the larger the beam sweeping range to be determined; on the contrary, the smaller the current displacement deviation value is, the smaller the beam sweeping range to be determined.

For example, it is assumed that the displacement reference value is the moving speed of the UE, which can be expressed as Vt; the preset sweeping threshold value is the predetermined speed threshold value, which can be expressed as V0. Then the UE can calculate the difference between the two to obtain the speed difference ΔV, that is, ΔV=Vt−V0.

At step 1222, the first preset sweeping range information corresponding to the current displacement deviation value is determined according to the current displacement deviation value and the preset sweeping range configuration information, so as to obtain target sweeping range information.

In the present disclosure, according to the difference of the first preset sweeping range information, the implementation of the step 1222 may include at least two cases. The following will take the displacement reference value as the moving speed of the UE as an example for description:

Case 1: The first preset sweeping range information is the preset number of beam deviations.

Then the preset sweeping range configuration information may include: a correspondence between the preset speed difference and the preset number of deviation beams. For example, it may be as shown in Table 1:

TABLE 1

| Speed difference | number of deviation beams |
|---|---|
| ΔV1 | N1 |
| ΔV2 | N2 |
| ΔV3 | N3 |

when ΔV is equal to ΔV1, it can be seen from the Table 1 that the corresponding number of deviation beams is N1. The subsequent UE may perform beam sweeping according to the original matching beam pair information and the number of deviation beams based on a preset rule, so as to re-determine the best matched beam pair.

Case 2: The first preset sweeping range information is first preset coverage angle information, and the first preset coverage angle information indicates a coverage angle range within which the UE performs the beam sweeping. In an embodiment, the coverage angle may be a spherical coverage angle.

Correspondingly, the preset sweeping range configuration information may include: a correspondence between the preset speed difference and the first preset coverage angle information, for example, it may be as shown in Table 2:

TABLE 2

| Speed difference | First preset coverage angle |
|---|---|
| ΔV1 | α1 |
| ΔV2 | α2 |
| ΔV3 | α3 |

Similarly, when ΔV is equal to ΔV1, it can be known from Table 2 that the corresponding first preset coverage angle is α1, that is, the first target coverage angle is α1.

At step 1223, the to-be-swept beams are determined according to the target sweeping range information and the original matching beam pair information.

Corresponding to the above case 1, the UE may determine the to-be-swept beams according to the number of deviation beams determined in real time as N1 and the original matching beam pair information. For example, assuming N1=1, combined with the example in FIG. 1, the UE can sweep a beam to both sides according to the preset rule, such as centering on beam c and beam 2, that is determining the beams 1 to 3 transmitted by the base station and beams b to d transmitted by the UE as the to-be-swept beams.

Corresponding to the above case 2, that is, the target scanning range information determined by the UE includes the first target coverage angle. In one embodiment, the UE can accurately determine the to-be-swept beams according to its beam tracking capability information and the first target coverage angle.

FIG. 7 is a flowchart of another beam correspondence method according to an example of the present disclosure. The step 1223 may include:

At step 12231, a first number of deviation beams is determined according to the beam tracking capability information of the user equipment and the first target coverage angle.

The beam tracking capability information of the UE refers to the capability to distinguish beam granularity, and is related to factors such as the number of beams that the UE can transmit, the ability to dynamically adjust the beams and other factors.

For example, the preset coverage angle is a spherical coverage angle in the range of 60 degrees. For UE1 that can transmit 32 beams, assuming that 6 beams need to-be-swept within the spherical coverage angle range of 60 degrees, for UE2 that can transmit 8 beams, only 2 beams need to be swept within the 60-degree spherical coverage angle range.

Therefore, in the present disclosure, the UE can determine the number of deviation beams suitable for the UE according to the beam coverage capability information and the first target coverage angle, which is referred to as the first number of deviation beams in the present disclosure.

At step 12232, the to-be-swept beams are determined according to the original matching beam pair information and the first number of deviation beams.

This step 12232 is similar to the above step 1223 in the implementation manner for the case 1, and it is sufficient to refer to each other. In the embodiments of the present disclosure, when the target sweeping range information determined by the UE according to the current displacement deviation value includes the first target coverage angle, the UE can also accurately determine the to-be-swept beams according to the beam tracking capability information, so as to avoid performing the beam sweeping on the redundant beams that are not possible to be used in the subsequent beam sweeping process and wasting power consumption.

It can be seen that in the first implementation of step 122-2, when the UE needs to perform the beam sweeping, it can dynamically determine the corresponding to-be-swept beams according to the current displacement deviation value determined by the displacement reference value and the preset scanning threshold, which can more accurately determine the information on the to-be-swept beams and ensures that the beam correspondence result is more accurate, while reducing the power consumption required by the beam sweeping as much as possible, and reducing the power consumption of the UE.

In the second implementation manner, the beam sweeping range determined by the UE is irrelevant to the currently determined displacement reference value.

The preset sweeping range configuration information includes: second preset sweeping range information; wherein the second preset sweeping range information may be system configuration information sent to the UE when the base station detects any of the foregoing timings.

In an embodiment of the present disclosure, the second preset sweeping range information may also be preset sweeping range information determined by the base station according to a maximum displacement reference value of the user equipment.

FIG. 8 is a flowchart of another beam correspondence method according to an example of the present disclosure. The step 122-2 may include:

At step 122-21, a second number of deviation beams is determined according to the second preset sweeping range information.

The method of determining the second number of deviation beams is similar to the method of determining the first number of deviation beams described above, except that, in the embodiment of the present disclosure, the second preset sweeping range information is irrelevant to the relative position change between the base station and the UE.

In another embodiment of the present disclosure, the second preset sweeping range information may include: second preset coverage angle information, which is used to instruct the UE to center on the original matched beam pair, and perform the beam sweeping according to the second preset coverage angle information.

Correspondingly, step 122-21 may include: determining the second number of deviation beams according to the beam tracking capability of the user equipment and the second preset coverage angle information.

The implementation process of this step 122-21 is similar to the above-mentioned step 12231, which can be referred to each other.

At step 122-22, the to-be-swept beams are determined according to the original matching beam pair and the second number of deviation beams.

The implementation of steps 122-22 is similar to the implementation process of step 12232 described above, and will not be repeated here.

It can be seen that in the second implementation of step 122-2, when the UE needs to perform the beam sweeping, it can quickly determine the information of the to-be-swept beams according to the pre-configured sweeping range information, which saves the UE calculation and avoids the UE from occupying computing resources for a long time and affecting other services of UE.

The first case of step 122 is described in detail above. In the first case, when the UE determines that beam sweeping is to be performed, it can automatically determine the beam sweeping range information according to the preset sweeping range configuration information without requesting the base station to configure the beam sweeping range information for the UE and effectively save signaling overhead.

In the second case, the above step 122 may include: obtaining the beam sweeping range information issued by the base station.

In this case, when the UE determines that the beam sweeping is to be performed, the UE may request the base station to configure the beam sweeping range for the UE.

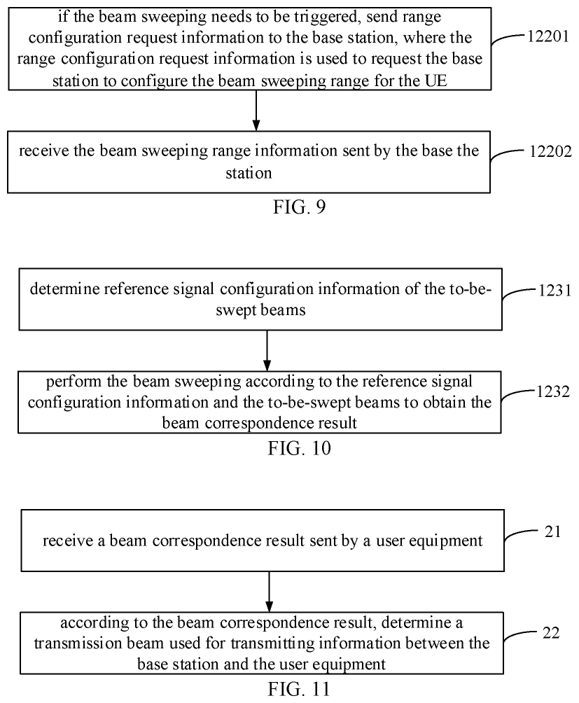

FIG. 9 is a flowchart of another beam correspondence method according to an example of the present disclosure. The step 122 may include:

At step 12201, if the beam sweeping is to be triggered, range configuration request information is sent to the base station, where the range configuration request information is used to request the base station to configure the beam sweeping range for the UE;

wherein the range configuration request information may include at least one of the following information in addition to an equipment identifier of the UE: the displacement reference value, the beam tracking capability information of the UE, the maximum displacement reference value, and the like.

If the range configuration request information includes the displacement reference value, the base station can dynamically configure the beam sweeping range for the UE according to the preset sweeping range configuration information and the displacement reference value agreed by the system.

If the range configuration request information includes the beam tracking capability information of the UE, the base station can determine the number of deviation beams according to the beam tracking capability information of the UE when determining the preset coverage angle information according to the preset sweeping range configuration information, thereby determining the to-be-swept beams.

If the range configuration request information includes the maximum displacement reference value of the UE, the base station can determine the preset beam sweeping range according to the preset sweeping range configuration information and the maximum displacement reference value of the UE and send the preset beam sweeping range to the UE.

For the case where the range configuration request information includes multiple pieces of information, such as including the displacement reference value and the beam tracking capability information at the same time, the method of the base station determining the beam sweeping range is similar to the embodiment shown in FIG. 7 and will be described in detail later.

At step 12202, the beam sweeping range information sent by the base the station is received.

In an embodiment of the present disclosure, the beam sweeping range may be the number of deviation beams notified to the UE by the base station, or may be coverage angle information.

The embodiments of the present disclosure are applicable to the situation where the UE cannot learn the preset sweeping range configuration information, or the situation where the UE needs to learn the accurate beam sweeping range. Adopting the second case to determine the beam sweeping range information can reduce the amount of calculation of the UE, save the power consumption of the UE, and can also accurately determine the beam sweeping range, thereby obtaining accurate beam correspondence results.

At step 123, the beam correspondence result is obtained by performing the beam sweeping according to the beam sweeping range information.

FIG. 10 is a flowchart of another beam correspondence method according to an example of the present disclosure. The step 123 may include:

At step 1231, reference signal configuration information of the to-be-swept beams is determined.

In the present disclosure, the UE needs to determine the beam correspondence result based on the measurement result of the reference signal on the swept beam. Therefore, before performing the beam sweeping, it is necessary to first determine the configuration of the reference signal on the to-be-swept beams transmitted by the base station.

In an embodiment of the present disclosure, if the reference signal is always configured on the beam transmitted by the base station, and the configuration of the reference signal does not change due to changes in the transmission time or spatial distribution of the beam, the UE can determine the previously obtained reference signal configuration information as the reference signal configuration information of the to-be-swept beams. Alternatively, the sweeping configuration information sent by the base station to the UE carries the reference signal configuration information, and the reference signal configuration information is used to inform the UE of the configuration information of the downlink reference signal in a downlink sweeping beam, so that the UE receives the downlink reference signal according to the reference signal configuration information, and determine the best matching beam pair based on the reference signal measurement result.

In another embodiment of the present disclosure, if the reference signal configuration of the base station on the to-be-swept beams changes, for example, a reference signal configured specifically for the beam sweeping, the base station may send the reference signal configuration information determined in real time to the UE.

At step 1232, the beam sweeping is performed according to the reference signal configuration information and the to-be-swept beams to obtain the beam correspondence result.

Still taking the example of FIG. 1, assuming the to-be-swept beams includes:

beam b, beam c, beam d transmitted by UE1 and beams 1 to 3 transmitted by the base station; then UE1 may use the antenna module transmitting beam b to receive beam 1, beam 2, and beam 3 respectively, and obtain a reference signal measurement result; in the same way, the UE1 may use the antenna modules transmitting beam c and beam d to receive beam 1, beam 2, and beam 3 respectively, and perform a total of 9 beam correspondence measurements to obtain 9 reference signal measurement results. Finally, the UE1 determines the beam correspondence result according to the best reference signal measurement result, that is, the information on a best matching beam pair. In the present disclosure, after determining the beam correspondence result, the UE may determine the transmission beam used when sending uplink information at the current moment.

For example, if the best reference signal measurement result is obtained when the antenna module transmitting beam b receives beam 3, the beam b can be used to transmit the uplink information to be sent.

At step 13, the beam correspondence result is sent to the base station, so that the base station determines a transmission beam with reference to the beam correspondence result.

In order for the base station to receive the uplink information sent by the UE, before transmitting the uplink information to be sent, the UE needs to report the correspondence of beam b and beam 3 to the base station.

The beam correspondence method applied to the UE side provided by the present disclosure has been described in detail above.

In the present disclosure, when the relative position of the UE with the base station changes in the beam correspondence state, the beam sweeping can be triggered based on the sweeping configuration information to re-determine the information on a best matching beam pair at the current timing, so as to prepare for subsequent information transmission, and ensure that when high-frequency beams such as millimeter wave band beams are used to transmit information between the UE and the base station, the best matched beam pairs can be used to transmit information, and the information transmission performance of the system in the high-frequency band can be improved.

Correspondingly, the present disclosure also provides a beam correspondence method applied in a base station side. FIG. 11 is a flowchart of another beam correspondence method according to an example of the present disclosure. The method may include the following steps:

At step 21, a beam correspondence result sent by user equipment is received, where the beam correspondence result indicates the information on a best matching beam pair re-determined after the user equipment performs a beam sweeping in a beam correspondence state.

Corresponding to step 13 above, the base station may receive the beam correspondence result sent by the UE through preset signaling.

At step 22, according to the beam correspondence result, a transmission beam used for transmitting information between the base station and the user equipment is determined.

In the present disclosure, the base station can determine the transmission beam with reference to the beam correspondence result when the original matching beam pair is known.

The transmission beam includes: a downlink transmission beam, and/or, an uplink transmission beam. The downlink transmission beam is a beam transmitted when the base station sends downlink information to the UE. The uplink transmission beam is a beam transmitted when the UE sends uplink information to the base station. Based on the information of the uplink beam, the base station can determine whether the antenna module for the UE is to be adjusted.

Generally, after receiving the beam correspondence result, the base station may adjust the transmission beam in time. As in the above example, the downlink transmission beam for UE1 is adjusted from beam 2 to beam 3, and the corresponding uplink transmission beam information is adjusted from beam c to beam b, so that the newly determined best matching beam pair (beam b, beam 3) can be used for transmitting information with UE1.

In some cases, the base station may not immediately adjust the beam pair information according to relevant factors after receiving the beam correspondence result. As shown in the example shown in FIG. 1, if the base station is currently using the beam 2 to send downlink information to the UE1, the base station may not adjust the downlink transmission beam immediately.

To ensure smooth subsequent information transmission between the base station and the UE, the base station may also send a transmission beam determination result to the UE, so that the UE determines whether to use the newly determined best matching beam pair for transmitting information, for example, sending uplink information to the base station.

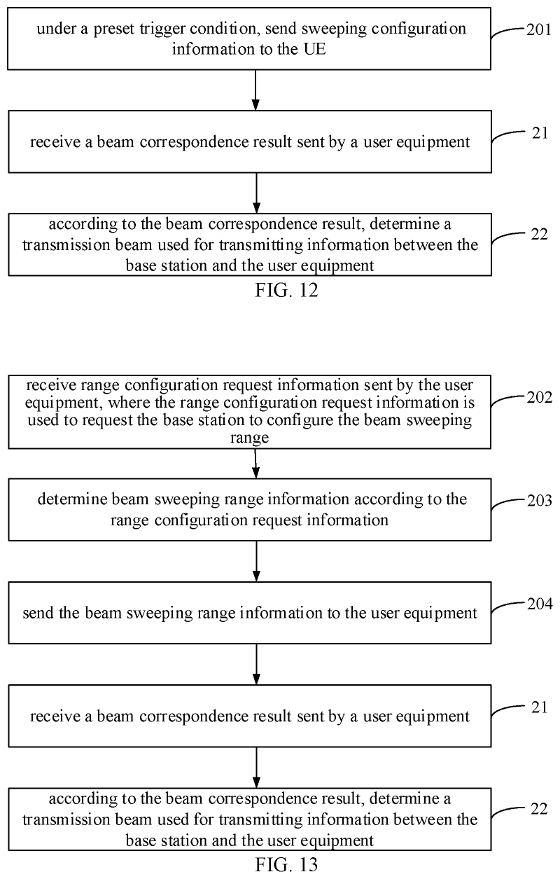

FIG. 12 is a flowchart of another beam correspondence method according to an example of the present disclosure. Before step 21, the method may also include:

At step 201, under a preset trigger condition, sweeping configuration information is sent to the UE. The sweeping configuration information indicates that in the beam correspondence state, the beam sweeping is performed to re-determine the best matching beam pair when a relative position between an antenna module of the user equipment and the base station changes.

This step corresponds to step 11 above. As mentioned above, the base station can send the sweeping configuration information to the UE through broadcast signaling, upper layer signal signaling, physical layer signaling, when detects that the UE is connected to network, a millimeter wave module is initiated, or an antenna module of the millimeter frequency band is initiated in the case that the millimeter wave module is initiated. The sweeping configuration information includes at least: trigger configuration information, which is used to inform the UE that when the preset trigger condition is met in the beam correspondence state, the beam sweeping is triggered to re-determine the best matching beam pair. In another embodiment of the present disclosure, the sweeping configuration information may further include: reference signal configuration information, sweeping range configuration information, and the like.

FIG. 13 is a flowchart of another beam correspondence method according to an example of the present disclosure. Before step 21, the method may further include:

At step 202, range configuration request information sent by the user equipment is received, where the range configuration request information is used to request the base station to configure the beam sweeping range.

The step 202 corresponds to step 12201 in the embodiment shown in FIG. 9 above. When the UE determines that beam sweeping is to be triggered in the beam correspondence state, it can send range configuration request information to the base station to request the base station to inform the beam sweeping range information for subsequently performing the beam sweeping to re-determine the best matching beam pair.

At step 203, beam sweeping range information is determined according to the range configuration request information;

At step 204, the beam sweeping range information is sent to the user equipment.

The step 204 corresponds to step 12202 in the embodiment shown in FIG. 9, and it is sufficient to refer to each other.

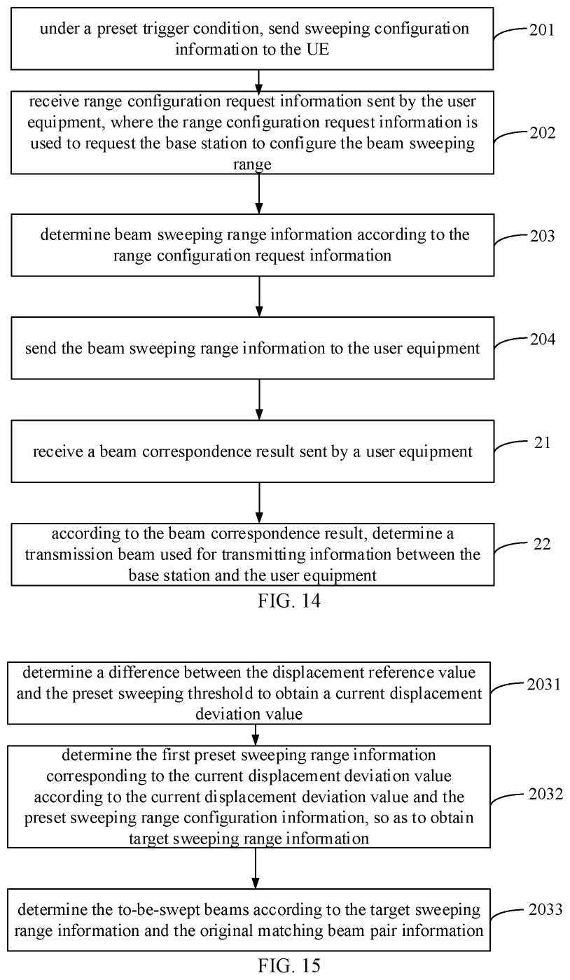

It can be understood that, in another embodiment of the present disclosure, the above steps 202 to 204 may also be set after step 201, as shown in FIG. 14.

Regarding the specific implementation manner of step 203, similar to the manner in which the UE itself determines the beam sweeping range, the base station may also inform the UE to determine all or part of the beams as to-be-swept beams.

In an embodiment, the base station may determine all beams as the to-be-swept beams according to the preset sweeping range configuration information; similar to the above step 122-1, for example, as shown in FIG. 1, the base station may select beams 1 to 5 and beam a, beam b, beam c, beam d transmitted by the UE as the to-be-swept beams of UE1.

In another embodiment of the present disclosure, the base station may also determine part of the beams as the to-be-swept beams of the UE according to the preset sweeping range configuration information and the original matching beam pair information, which is similar to the foregoing step 122-2.

For the case where the base station determines part of the beams as to-be-swept beams, the implementation of the foregoing step 203 may include at least the following two manners:

In the first implementation manner, the base station dynamically determines the to-be-swept beams in combination with a displacement reference value reported by the UE and preset sweeping range configuration information.

In the embodiment of the present disclosure, the range configuration request information includes: a displacement reference value of the user equipment; the displacement reference value represents a relative displacement between the antenna module of the user equipment and the base station.

The preset sweeping range configuration information includes: a correspondence between the preset displacement deviation value and first preset sweeping range information;

The preset displacement deviation value corresponds to the displacement reference value, for example, it may be a value such as a speed deviation value, a rotation angle, and the like. The first preset sweeping range information may be a preset number of deviation beams or may be preset coverage angle information.

FIG. 15 is a flowchart of another beam correspondence method according to an example of the present disclosure. The step 203 may include:

At step 2031, a difference between the displacement reference value and the preset sweeping threshold is determined to obtain a current displacement deviation value;

In the present disclosure, the current displacement deviation value indicates how much the relative position between the UE and the base station has changed at the current moment since the last transmission is completed. It can be predicted that the larger the current displacement deviation value, the larger the beam sweeping range to be determined; on the contrary, the smaller the current displacement deviation value is, the smaller the beam sweeping range to be determined.

At step 2032, the first preset sweeping range information corresponding to the current displacement deviation value is determined according to the current displacement deviation value and the preset sweeping range configuration information, so as to obtain target sweeping range information.

Similar to the above step 1222, in the present disclosure, according to the difference of the preset sweeping range information, the step 2032 can be implemented in at least two cases. The following will take the displacement reference value as the moving speed of the UE as an example for description:

Case 1: The first preset sweeping range information is the preset number of beam deviations.

The preset sweeping range configuration information may include: a correspondence between a preset speed difference and a preset number of deviation beams, which may be as shown in Table 1: Then the base station can determine the corresponding preset number of deviation beams according to the current displacement deviation value of the UE, thereby determining the target number of deviation beams.

Case 2: The first preset sweeping range information is first preset coverage angle information, and the first preset coverage angle information indicates a coverage angle range within which the UE performs the beam sweeping. In an embodiment, the coverage angle may be a spherical coverage angle.

Correspondingly, the preset sweeping range configuration information may include: the correspondence between the preset speed difference and first preset coverage angle information, which may refer to the example shown in Table 2 above. Then the base station may determine the corresponding first preset coverage angle information according to the current displacement deviation value of the UE, thereby determining the first target coverage angle.

At step 2033, the to-be-swept beams are determined according to the target sweeping range information and the original matching beam pair information.

Corresponding to the above situation 1, the base station may determine the to-be-swept beams according to the target number of deviation beams determined in real time, such as N1 in the Table. 1 and the original matching beam pair information. For example, assuming N1=1, combined with the example in FIG. 1, the base station can sweep a beam to both sides according to a preset rule, such as centering on beam c and beam 2, that is determining the beams 1 to 3 transmitted by the base station and beams b to d transmitted by the UE as the to-be-swept beams.

Corresponding to the above case 2, the target sweeping range information determined by the base station includes the first target coverage angle. In one embodiment, the base station can accurately determine the to-be-swept beams according to the beam tracking capability information of the UE and the first target coverage angle.

Regarding how the base station obtains the beam tracking capability information of the UE, in one embodiment, the UE may report the beam tracking capability information of itself to the base station when the UE first accesses the cell network covered by the base station, initiates the millimeter wave module, or initiates the antenna module in the millimeter wave frequency band. That is, before step 202, the method may further include: obtaining the beam tracking capability information of the UE. For example, receiving the beam tracking capability information actively reported by the UE.

In another embodiment of the present disclosure, the UE may also carry its beam tracking capability information through the range configuration request information, that is, the range configuration request information may further include: the beam tracking capability information of the UE.

The embodiment shown in FIG. 15 is similar to the embodiment shown in FIG. 6 above, and the specific implementation process can be referred to each other.

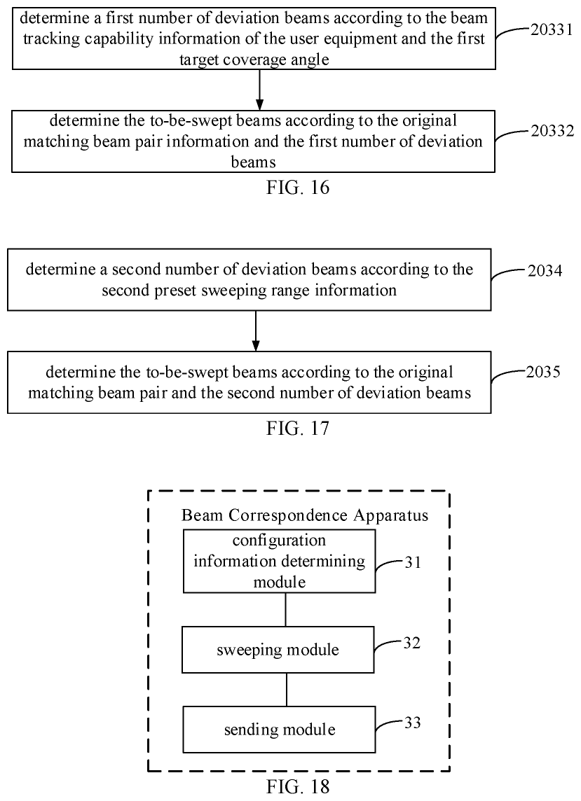

FIG. 16 is a flowchart of another beam correspondence method according to an example of the present disclosure. The step 2033 may include:

At step 20331, a first number of deviation beams is determined according to the beam tracking capability information of the user equipment and the first target coverage angle;

The beam tracking capability information of the UE refers to the capability to distinguish beam granularity, and is related to factors such as the number of beams that the UE can transmit, the ability to dynamically adjust the beams and other factors.

For example, the preset coverage angle is a spherical coverage angle in the range of 60 degrees. For UE1 that can transmit 32 beams, assuming that 6 beams need to-be-swept within the spherical coverage angle range of 60 degrees, for UE2 that can transmit 8 beams, only 2 beams need to-be-swept within the 60-degree spherical coverage angle range.

Therefore, in the present disclosure, the base station can determine the number of deviation beams suitable for the UE according to the beam coverage capability information of the UE and the first target coverage angle, which is referred to as the first number of deviation beams in the present disclosure.

At step 20332, the to-be-swept beams are determined according to the original matching beam pair information and the first number of deviation beams.

The embodiment shown in FIG. 16 is similar to the embodiment shown in FIG. 7 above, and the specific implementation process can be referred to each other.

In the embodiments of the present disclosure, when the target sweeping range information determined by the base station according to the current displacement deviation value of the UE includes the first target coverage angle, the base station can also accurately determine the to-be-swept beams according to the beam tracking capability information of the UE to avoid performing the beam sweeping on the redundant beams that are not possible to be used by the UE in the subsequent beam sweeping process and wasting power consumption.

It can be seen that in the first implementation manner of step 203, when the base station learns that the UE needs to perform beam sweeping, it can dynamically determine the corresponding to-be-swept beams according to the current displacement deviation value and based on the displacement reference value and preset sweeping range configuration information reported by the UE, so as to more accurately determine the to-be-swept beams information for the UE.

In the second implementation manner, the base station only determines the to-be-swept beams for the UE based on the preset sweeping range configuration information.

In the embodiment of the present disclosure, the preset sweeping range configuration information includes second preset sweeping range information; in an embodiment of the present disclosure, the second preset sweeping range information may also be preset sweeping range information determined by the base station according to a maximum displacement reference value of the UE.

The base station can learn the maximum displacement reference value of the UE according to related technologies. For example, when the UE accesses the cell network covered by the base station, it actively reports its maximum displacement reference value to the base station, such as the maximum moving speed, the maximum attitude change, and other information.

In an embodiment, the system may agree that the displacement reference values of different ranges correspond to preset beam sweeping ranges, and the base station may determine the corresponding preset sweeping range according to the maximum displacement value of the UE, that is, determine the second preset sweeping range information.

FIG. 17 is a flowchart of another beam correspondence method according to an example of the present disclosure. The step 203 may include:

At step 2034, a second number of deviation beams is determined according to the second preset sweeping range information.

The method of determining the second number of deviation beams is similar to the method of determining the first number of deviation beams described above, except that, in the embodiment of the present disclosure, the second preset sweeping range information is not affected by the relative position change between the UE and the base station, that is, the displacement reference value.

In another embodiment of the present disclosure, the second preset sweeping range information may include: second preset coverage angle information, which is used to instruct the UE to center on the original matched beam pair, and perform the beam sweeping according to the second preset coverage angle information.

Correspondingly, step 2034 may include: determining the second number of deviation beams according to the beam tracking capability of the UE and the second preset coverage angle information.

At step 2035, the to-be-swept beams are determined according to the original matching beam pair and the second number of deviation beams.

The embodiment shown in FIG. 17 is similar to the embodiment shown in FIG. 8, and the specific implementation process can be referred to each other.

It can be seen that, in the second implementation manner of step 203, when the base station determines that the UE needs to perform the beam sweeping, it can quickly determine the to-be-swept beams information for the UE according to the pre-configured sweeping range information, so as to improve the configuration efficiency of the beam sweeping range.

For the foregoing method embodiments, for the sake of simple description, they are all expressed as combination of a series of actions, but one of ordinary skill in the art should understand that the present disclosure is not limited by the described sequence of actions, as some steps can be performed in other order or simultaneously according to the present disclosure.

Secondly, those skilled in the art should also understand that the embodiments described in the specification are all optional, and the involved actions and modules are not necessarily required by the present disclosure.

Corresponding to the foregoing method embodiments, the present disclosure further provides corresponding devices and corresponding terminals embodiments.

Correspondingly, the present disclosure provides a beam correspondence apparatus, which can be applicable to UE.

FIG. 18 is a block diagram of a beam correspondence apparatus according to an example of the present disclosure. The apparatus may include:

a configuration information determining module 31, configured to determine sweeping configuration information for a beam correspondence state, wherein the sweeping configuration information indicates that in the beam correspondence state, the user equipment performs a beam sweeping to re-determine a best matching beam pair when a relative position between an antenna module of the user equipment and the base station changes.

In an apparatus embodiment of the present disclosure, the configuration information determining module 31 may be configured to receive the sweeping configuration information issued by the base station.

a sweeping module 32, configured to, in the beam correspondence state, trigger the beam sweeping according to the sweeping configuration information to obtain a beam correspondence result, wherein the beam sweeping is performed to re-determine the best matching beam pair;

a sending module 33, configured to sending the beam correspondence result to the base station, so that the base station determines a transmission beam with reference to the beam correspondence result.

In an apparatus embodiment of the present disclosure, the sweeping configuration information determined by the configuration information determining module 31 at least includes: trigger configuration information used to instruct the user equipment to trigger the beam sweeping when a preset trigger condition is met;

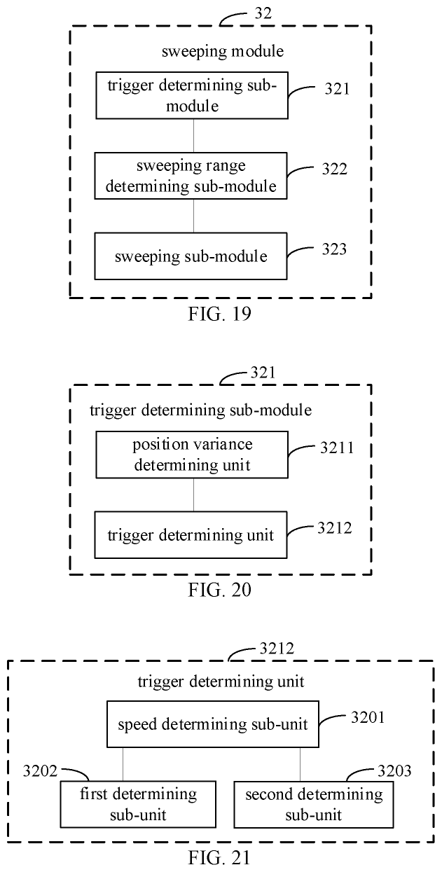

Correspondingly, FIG. 19 is a block diagram of another beam correspondence apparatus according to an example of the present disclosure. On the basis of the apparatus embodiment shown in FIG. 18, the sweeping module 32 may include:

a trigger determining sub-module 321, configured to, in the beam correspondence state, determine whether the beam sweeping is to be triggered currently according to the trigger configuration information;

a sweeping range determining sub-module 322, configured to in response to that the beam sweeping is to be performed, determine beam sweeping range information;

a sweeping sub-module 323, configured to perform the beam sweeping according to the beam sweeping range information to obtain the beam correspondence result.

In another apparatus embodiment of the present disclosure, the trigger configuration information may include a preset sweeping trigger threshold.

Correspondingly, FIG. 20 is a block diagram of another beam correspondence apparatus according to an example of the present disclosure. On the basis of the apparatus embodiment shown in FIG. 19, the trigger determining sub-module 321 may include:

a position variance determining unit 3211, configured to determine a displacement reference value at a current timing relative to a most recent information transmission, wherein the displacement reference value indicates a relative displacement between the base station and an antenna module of the user equipment;

a trigger determining unit 3212, configured to compare the displacement reference value with the preset sweeping trigger threshold to determine whether the beam sweeping is to be triggered currently.

In another apparatus embodiment of the present disclosure, the trigger configuration information further includes: preset period duration information.

Correspondingly, the position variance determining unit 3211 may be configured to, after the most recent information transmission is completed, in response to detecting that a position of the antenna module relative to the base station has changed, determine the displacement reference value according to the preset period duration information.

In another apparatus embodiment of the present disclosure, the displacement reference value includes a current moving speed of the UE relative to the base station; the preset sweeping trigger threshold is a preset speed threshold.

Correspondingly, FIG. 21 is a block diagram of another beam correspondence apparatus according to an example of the present disclosure. On the basis of the apparatus embodiment shown in FIG. 20, the trigger determining unit 3212 may include:

a speed determining sub-unit 3201, configured to determine whether the current moving speed is greater than or equal to the preset speed threshold;

a first determining sub-unit 3202, configured to in response to the current moving speed being greater than or equal to the preset speed threshold, determine that the beam sweeping is to be triggered currently;

a second determining sub-unit 3203, configured to in response to the current moving speed being less than the preset speed threshold, determining that the beam sweeping does not need to be triggered currently.

In another apparatus embodiment of the present disclosure, the sweeping range determining sub-module 322 includes any of the following units

a first range determining unit 322-1, configured to determine the beam sweeping range information according to preset sweeping range configuration information;

a second range determining unit 322-2, obtain the beam sweeping range information issued by the base station.

the first range determining unit may include any of the following sub-units:

a first beam determining sub-unit 322-11, configured to determine all beams as to-be-swept beams according to the preset sweeping range configuration information;

a second beam determining sub-unit 322-12, configured to determine part of the beams as the to-be-swept beams according to the preset sweeping range configuration information and original matching beam pair information; wherein the original matching beam pair information is information on a best matching beam pair determined in the most recent information transmission.

In an embodiment of the present disclosure, the preset sweeping range configuration information may include: a correspondence between a preset displacement deviation value and first preset sweeping range information.

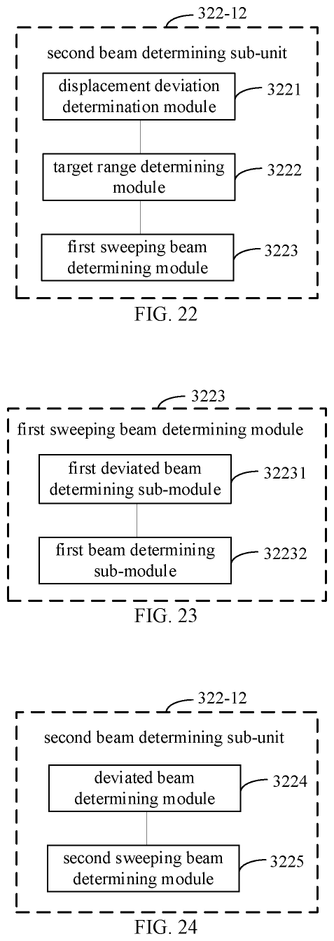

Correspondingly, FIG. 22 is a block diagram of another beam correspondence apparatus according to an example of the present disclosure. The second beam determining sub-unit 322-12 may include:

a displacement deviation determination module 3221, configured to determine a difference between the displacement reference value and the preset sweeping threshold to obtain the current displacement deviation value;

a target range determining module 3222, configured to determine the first preset sweeping range information corresponding to the current displacement deviation value according to the current displacement deviation value and the preset sweeping range configuration information, so as to obtain target sweeping range information;

a first sweeping beam determining module 3223, configured to determine the to-be-swept beams according to the target sweeping range information and the original matching beam pair information.

In another apparatus embodiment, the first preset sweeping range information may include: first preset coverage angle information; the target sweeping range information may include: a first target coverage angle which is the first preset coverage angle information corresponding to the current displacement deviation value.

Correspondingly, FIG. 23 is a block diagram of another beam correspondence apparatus according to an example of the present disclosure. On the basis of the apparatus embodiment shown in FIG. 21, the first sweeping beam determining module 3223 may include:

a first deviated beam determining sub-module 32231, configured to determine a first number of deviation beams according to the beam tracking capability information of the user equipment and the first target coverage angle;

a first beam determining sub-module 32232, configured to determine the to-be-swept beams according to the original matching beam pair information and the first number of deviation beams.

In another apparatus embodiment of the present disclosure, the preset sweeping range configuration information includes: second preset sweeping range information.

Correspondingly, FIG. 24 is a block diagram of another beam correspondence apparatus according to an example of the present disclosure. The second beam determining sub-unit 322-12 may include:

a deviated beam determining module 3224, configured to determine the second number of deviation beams according to the second preset sweeping range information;

a second sweeping beam determining module 3225, configured to determine the to-be-swept beams according to the original matching beam pair information and the second number of deviation beams.

In another apparatus embodiment of the present disclosure, he second preset sweeping range information may include: second preset coverage angle information;

Correspondingly, the deviated beam determining module 3224 may be configured to determine the second number of deviation beams according to the beam tracking capability information of the user equipment and the second preset coverage angle information.

In an apparatus embodiment of the present disclosure, the second preset sweeping range information may also be preset sweeping range information determined by the base station according to a maximum displacement reference value of the user equipment. The maximum displacement reference value may be a maximum moving speed of the UE, or the maximum amount of posture change, such as attribute information such as the maximum rotatable angle and the maximum angular acceleration.

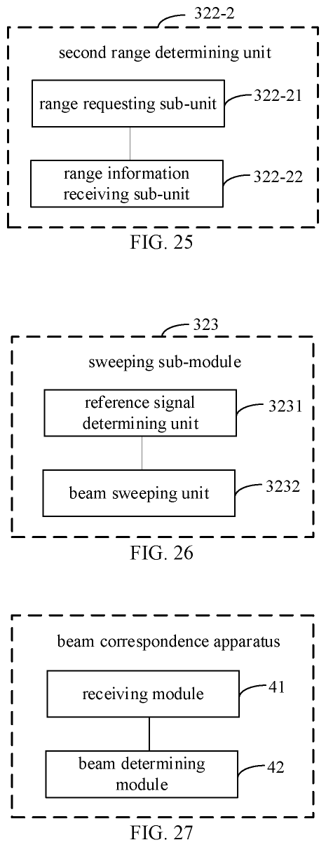

FIG. 25 is a block diagram of another beam correspondence apparatus according to an example of the present disclosure. The second range determining unit 322-2 may include:

a range requesting sub-unit 322-21, configured to send range configuration request information to the base station, where the range configuration request information is used to request the base station to configure a beam sweeping range for the user equipment;

a range information receiving sub-unit 322-22, configured to receive the beam sweeping range information sent by the base station.

FIG. 26 is a block diagram of another beam correspondence apparatus according to an example of the present disclosure. On the basis of the apparatus embodiment shown in FIG. 19, the sweeping sub-module 323 may include:

a reference signal determining unit 3231, configured to determine reference signal configuration information of the to-be-swept beams;

a beam sweeping unit 3232, configured to perform the beam sweeping according to the reference signal configuration information and the to-be-swept beams to obtain the beam correspondence result.

In another apparatus embodiment of the present disclosure, the reference signal determining unit 32321 may be configured to receive the reference signal configuration information for the to-be-swept beams sent by the base station.

The present disclosure also provides a beam correspondence apparatus, which is applied in the base station.

FIG. 27 is a block diagram of a beam correspondence apparatus according to an example of the present disclosure. The apparatus may include:

a receiving module 41, configured to receive a beam correspondence result sent by user equipment, wherein the beam correspondence result indicates information on a best matching beam pair re-determined after the user equipment performs a beam sweeping in a beam correspondence state;

a beam determining module 42, configured to determining a transmission beam used for transmitting information between the base station and the user equipment according to the beam correspondence result.

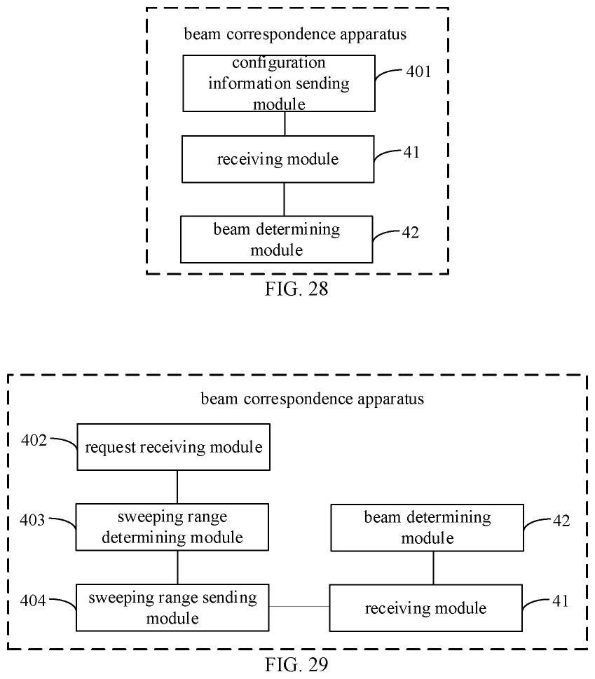

FIG. 28 is a block diagram of another beam correspondence apparatus according to an example of the present disclosure. On the basis of the apparatus embodiment shown in FIG. 27, the apparatus may further include:

a configuration information sending module 401, configured to send sweeping configuration information to the user equipment under a preset trigger condition;

the sweeping configuration information indicates that in the beam correspondence state, performs the beam sweeping to re-determine a best matching beam pair when a relative position between an antenna module of the user equipment and the base station changes.

the preset trigger condition includes at least one of the following:

when detecting that the user equipment is connected to network;

when detecting that the user equipment initiates the millimeter wave module;

when detecting that the user equipment initiates the antenna module of a millimeter wave frequency band.

FIG. 29 is a block diagram of another beam correspondence apparatus according to an example of the present disclosure. On the basis of the apparatus embodiment shown in FIG. 27, the apparatus may further include:

a request receiving module 402, configured to receive range configuration request information sent by the user equipment, wherein the range configuration request information is used to request the base station to configure a beam sweeping range for the user equipment;

a sweeping range determining module 403, configured to determine beam sweeping range information according to the range configuration request information;

a sweeping range sending module 404, configured to send the beam sweeping range information to the user equipment.

In another apparatus embodiment of the present disclosure, the above three modules may also be added to the apparatus embodiment shown in FIG. 28. Refer to the block diagram of another beam correspondence apparatus shown in FIG. 30 according to an example of the present disclosure.

In an apparatus embodiment of the present disclosure, the sweeping range determining module 403 includes any of the following sub-modules:

a first sweeping beam determining sub-module 403-1, configured to determine all beams as to-be-swept beams according to preset sweeping range configuration information;

a second sweeping beam determining sub-module 403-2, configured to determine part of the beams as the to-be-swept beams according to the preset sweeping range configuration information and original matching beam pair information; wherein the original matching beam pair information is information on a best matching beam pair determined in the most recent information transmission.

In another apparatus embodiment of the present disclosure, the range configuration request information includes: a displacement reference value of the user equipment which indicates a relative displacement between the antenna module of the user equipment and the base station;

the preset sweeping range configuration information includes: a correspondence between the preset displacement deviation value and first preset sweeping range information.

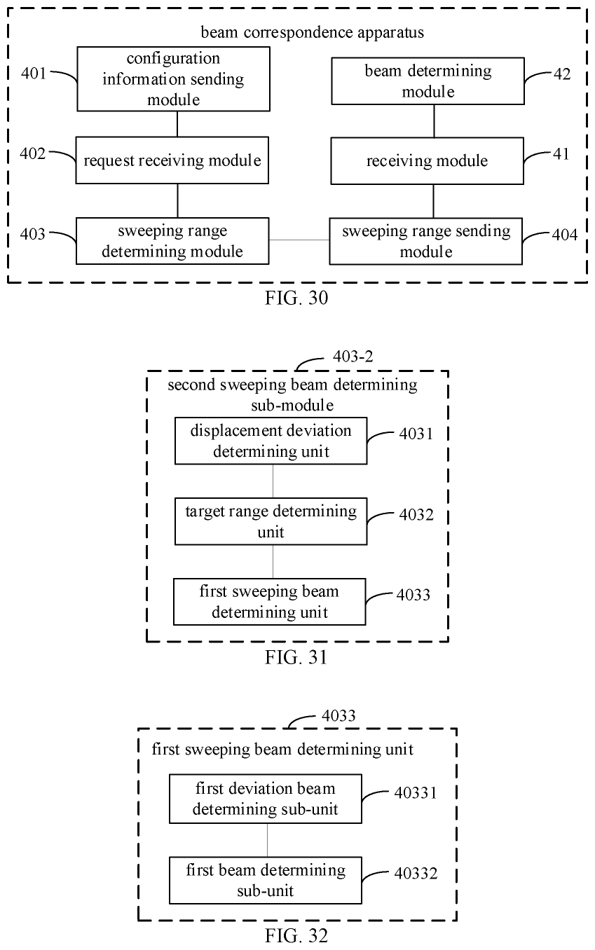

Correspondingly, FIG. 31 is a block diagram of another beam correspondence apparatus according to an example of the present disclosure. The second sweeping beam determining sub-module may include:

a displacement deviation determining unit 4031, configured to determine a difference between the displacement reference value and a preset sweeping threshold to obtain a current displacement deviation value;

a target range determining unit 4032, configured to determine the first preset sweeping range information corresponding to the current displacement deviation value according to the current displacement deviation value and preset sweeping range configuration information, so as to obtain target sweeping range information; and

a first sweeping beam determining unit 4033, configured to determine the to-be-swept beams according to the target sweeping range information and the original matching beam pair information.

In another apparatus embodiment of the present disclosure, the first preset sweeping range information may include: first preset coverage angle information; the target sweeping range information includes: a first target coverage angle which is the first preset coverage angle information corresponding to the current displacement deviation value.

Correspondingly, FIG. 32 is a block diagram of another beam correspondence apparatus according to an example of the present disclosure. On the basis of the apparatus embodiment shown in FIG. 31, the first sweeping beam determining unit 4033 may include:

a first deviation beam determining sub-unit 40331, configured to determine a first number of deviation beams according to the beam tracking capability information of the user equipment and the first target coverage angle;

a first beam determining sub-unit 40332, configured to determine the to-be-swept beams according to original matching beam pair information and the first number of deviation beams.

In another apparatus embodiment of the present disclosure, the preset sweeping range configuration information includes: second preset sweeping range information.

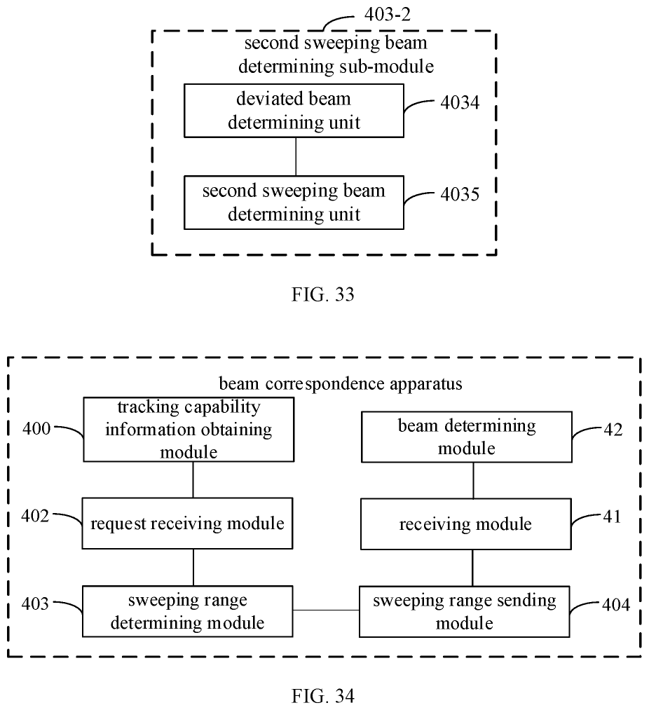

FIG. 33 is a block diagram of another beam correspondence apparatus according to an example of the present disclosure. The second sweeping beam determining sub-module 403-2 may include:

a deviated beam determining unit 4034, configured to determine the second number of deviation beams according to the second preset sweeping range information;

a second sweeping beam determining unit 4035, configured to determine the to-be-swept beams according to the original matching beam pair information and the second number of deviation beams.

In another apparatus embodiment of the present disclosure, the second preset range information includes: second preset coverage angle information:

correspondingly, the deviated beam determining unit 4034 may be configured to determine the second number of deviation beams according to the beam tracking capability information of the user equipment and the second preset coverage angle information.

In an embodiment of the present disclosure, the second preset sweeping range information may also be preset sweeping range information determined by the base station according to a maximum displacement reference value of the user equipment.

Regarding how the base station obtains the beam tracking capability information of the user equipment, in an apparatus embodiment, the range configuration request information may include: the beam tracking capability information of the user equipment.

FIG. 34 is a block diagram of another beam correspondence apparatus according to an example of the present disclosure. On the basis of the apparatus embodiment shown in FIG. 29, the apparatus may further include:

a tracking capability information obtaining module 400, configured to obtain the beam tracking capability information of the user equipment.

It should be noted here that in another apparatus embodiment of the present disclosure, the tracking capability information acquisition module 400 may also be added to the apparatus embodiment shown in FIG. 30.

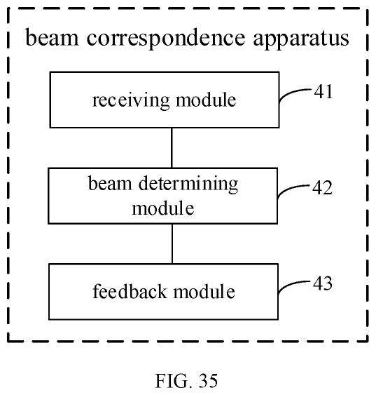

FIG. 35 is a block diagram of another beam correspondence apparatus according to an example of the present disclosure. On the basis of the apparatus embodiment shown in FIG. 27, the apparatus may further include:

a feedback module 43, configured to send a transmission beam determination result to the user equipment, so that the user equipment determines whether to use a newly determined best matching beam pair to transmit information.

Since the apparatus examples substantially correspond to the method examples, a reference may be made to part of the descriptions of the method examples for the related part. The apparatus examples described above are merely illustrative, wherein the units described as separate components may or may not be physically separated, and the components displayed as units may or may not be physical units, i.e., may be located in one place or may be distributed to multiple network units. Part or all of the modules may be selected according to actual requirements to implement the objectives of the solutions in the examples. Those of ordinary skill in the art may understand and carry out them without creative work.

Correspondingly, on the one hand, UE is provided, including:

a processor, and

memory for storing instructions executable by the processor;

wherein the processor is configured to:

determine sweeping configuration information for a beam correspondence state, wherein the sweeping configuration information indicates that in the beam correspondence state, the user equipment performs a beam sweeping to re-determine a best matching beam pair when a relative position between an antenna module of the user equipment and the base station changes.

in the beam correspondence state, trigger the beam sweeping according to the sweeping configuration information to obtain a beam correspondence result, wherein the beam sweeping is performed to re-determine the best matching beam pair;

send the beam correspondence result to the base station, so that the base station determines a transmission beam with reference to the beam correspondence result.

On the other hand, a base station is provided, including:

a processor, and

memory for storing instructions executable by the processor;

wherein the processor is configured to:

receive a beam correspondence result sent by user equipment, wherein the beam correspondence result indicates information on a best matching beam pair re-determined after the user equipment performs a beam sweeping in a beam correspondence state;

determine a transmission beam used for transmitting information between the base station and the user equipment according to the beam correspondence result.

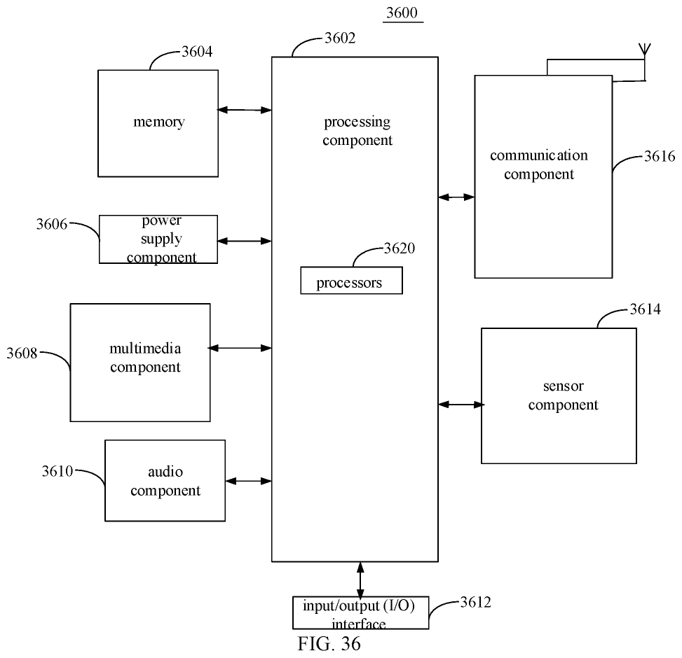

FIG. 36 is a schematic structural diagram illustrating user equipment 3600 according to an example. For example, the user equipment 3600 can be user equipment such as a mobile phone, a computer, a digital broadcasting user equipment, a messaging device, a game console, a tablet device, a medical device, fitness equipment, a personal digital assistant, or a wearable device such as a smart watch, smart glasses, a smart wristband, smart sneakers, or the like.

Referring to FIG. 36, the user equipment 3600 may include one or more of the following components: a processing component 3602, memory 3604, a power supply component 3606, a multimedia component 3608, an audio component 3610, an input/output (I/O) interface 3612, a sensor component 3614, and a communication component 3616.

The processing assembly 3602 generally controls the overall operation of the user equipment 3600, such as operations associated with displays, phone calls, data communications, camera operations, and recording operations. The processing component 3602 may include one or more processors 3620 for executing instructions to complete all or a part of blocks of the above method. In addition, the processing component 3602 may include one or more modules to facilitate the interaction between the processing component 3602 and other components. For example, the processing component 3602 may include a multimedia module to facilitate the interaction between the multimedia component 3608 and the processing component 3602.

The memory 3604 is configured to store different types of data to support operations at the user equipment 3600. Examples of such data include instructions for any application or method operated on the user equipment 3600, contact data, phonebook data, messages, pictures, videos, and so on. The memory 3604 may be implemented by any type of volatile or non-volatile memory devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or a CD.

The power source assembly 3606 provides power to different assemblies of the user equipment 3600. The power source assembly 3606 may include a power source management system, one or more power sources and other assemblies associated with generating, managing and distributing power for the user equipment 3600.

The multimedia component 3608 may include a screen for providing an output interface between the user equipment 3600 and a user. In some embodiments, the screen may include a Liquid Crystal Display (LCD) and/or a Touch Panel (TP). If the screen includes a touch panel, the screen may be implemented as a touch screen to receive an input signal from a user. The touch panel includes one or more touch sensors to sense touch, slip, and gestures on the touch panel. The above-mentioned touch sensor may not only sense the boundary of the touch or the sliding, but also detect duration and pressure related to the above-mentioned touch or sliding operation. In some embodiments, the multimedia component 3608 may include a front-facing camera and/or a rear camera. The front camera and/or rear camera may receive external multimedia data when the apparatus 3600 is in an operating mode, such as a photographing mode or a video mode. Each of the front-facing camera and the rear camera may be a fixed optical lens system or may be capable of focal length and optical zoom.

The audio component 3610 is configured to output and/or input an audio signal. For example, the audio component 3610 includes a microphone (MIC). When the user equipment 3600 is in an operating mode, such as a call mode, a recording mode, and a voice recognition mode, the MIC is configured to receive an external audio signal. The received audio signal may be further stored in the memory 3604 or sent via the communication component 3616. In some embodiments, the audio component 3610 also includes a speaker for outputting an audio signal.

The I/O interface 3612 provides an interface between the processing component 3602 and a peripheral interface module. The peripheral interface module may be a keyboard, click wheel, a button and the like. Such buttons may include but not limited to: a home button, a volume button, a start button, and a lock button.

The sensor component 3614 may include one or more sensors for providing state assessments in different aspects for the user equipment 3600. For example, the sensor component 3614 may detect the on/off state of the user equipment 3600, and relative locations of components, such as a display and a small keyboard of the user equipment 3600. The sensor component 3614 may also detect a position change of the user equipment 3600 or a component of the user equipment 3600, the presence or absence of contact of a user with the user equipment 3600, an orientation or acceleration/deceleration of the user equipment 3600 and a temperature change of the user equipment 3600. The sensor component 3614 may include a proximity sensor configured to detect presence of a nearby object without any physical contact. The sensor component 3614 may also include an optical sensor, such as a CMOS or CCD image sensor to be used in imaging application. In some embodiments, the sensor component 3614 may also include an acceleration sensor, a gyroscope sensor, a magnetic sensor, a pressure sensor, or a temperature sensor.

The communication component 3616 is configured to facilitate wired or wireless communication between the user equipment 3600 and other devices. The user equipment 3600 may access a wireless network based on a communication standard, such as WiFi, 2G, 3G, 4G LTE, 5G NR or a combination thereof. In some embodiments, the communication component 3616 may receive a broadcast signal or broadcast-related information from an external broadcast management system via a broadcast channel. In an exemplary embodiment, the communication component 3616 further includes a near field communication (NFC) module to facilitate short-range communication. For example, the NFC module may be implemented based on Radio Frequency Identification (RFID) technology, Infrared Data Association (IrDA) technology, Ultra Wide Band (UWB) technology, Bluetooth (BT) technology and other technology.

In an example, the electronic equipment 3600 may be implemented by one or more application specific integrated circuits (ASICs), digital signal processors (DSPs), digital signal processing devices (DSPDs), programmable logic devices (PLDs), a field programmable gate array (FPGA), a controller, a microcontroller, a microprocessor or other electronic elements for performing the above methods.

In an example, there is also provided a non-transitory computer readable storage medium including instructions, such as memory 3604 including instructions, where the instructions are executable by the processor 3620 of the user equipment 3600 to perform any of the methods of transmitting information as shown in FIGS. 2 to 10. For example, the non-transitory computer readable storage medium may be a Read-Only Memory (ROM), a Random Access Memory (RAM), CD-ROM, a magnetic tape, a floppy disk, and an optical data storage device and so on.

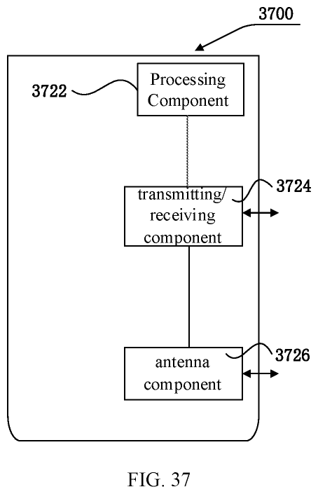

As illustrated in FIG. 37, FIG. 37 is a schematic structural diagram of a base station 3700 according to an exemplary embodiment. Referring to FIG. 37, the base station 3700 includes a processing component 3722, a wireless transmitting/receiving component 3724, an antenna component 3726, and a signal processing part specific to a wireless interface. The processing component 3722 may further include one or more processors.

One of the processors in the processing component 3722 may be configured to:

receive a beam correspondence result sent by user equipment, wherein the beam correspondence result indicates information on a best matching beam pair re-determined after the user equipment performs a beam sweeping in a beam correspondence state;

determine a transmission beam used for transmitting information between the base station and the user equipment according to the beam correspondence result.

In an example, there is also provided a non-transitory computer readable storage medium storing computer instructions, where the computer instructions are executable by the processing component 3722 of the base station 3700 to perform any of the beam correspondence methods as shown in FIGS. 11 to 17. For example, the non-transitory computer readable storage medium may be a Read-Only Memory (ROM), a Random Access Memory (RAM), CD-ROM, a magnetic tape, a floppy disk, and an optical data storage device and so on.

After considering the specification and practicing the present disclosure, the persons of skill in the prior art may easily conceive of other implementations of the present disclosure. The present disclosure is intended to include any variations, uses and adaptive changes of the present disclosure. These variations, uses and adaptive changes follow the general principle of the present disclosure and include common knowledge or conventional technical means in the prior art not disclosed in the present disclosure. The specification and examples herein are intended to be illustrative only and the real scope and spirit of the present disclosure are indicated by the claims of the present disclosure.

It is to be understood that the present disclosure is not limited to the precise structures described above and shown in the accompanying drawings and may be modified or changed without departing from the scope of the present disclosure. The scope of protection of the present disclosure is limited only by the appended claims.

1. A beam correspondence method, being applicable to user equipment, comprising:
determining sweeping configuration information for a beam correspondence state, wherein the sweeping configuration information indicates that in the beam correspondence state, the user equipment performs a beam sweeping to re-determine a best matching beam pair when a relative position between an antenna module of the user equipment and a base station changes;
in the beam correspondence state, triggering the beam sweeping according to the sweeping configuration information to obtain a beam correspondence result; and
sending the beam correspondence result to the base station, such that the base station determines a transmission beam with reference to the beam correspondence result.

2. The method of claim 1, wherein determining the sweeping configuration information for the beam correspondence state comprises:
receiving the sweeping configuration information issued by the base station.

3. The method of claim 1, wherein the sweeping configuration information at least comprises: trigger configuration information used to instruct the user equipment to trigger the beam sweeping when a preset trigger condition is met; and
wherein in the beam correspondence state, triggering the beam sweeping according to the sweeping configuration information to obtain the beam correspondence result comprises:
in the beam correspondence state, determining whether the beam sweeping is to be triggered currently according to the trigger configuration information;
in response to that the beam sweeping is to be performed, determining beam sweeping range information; and
performing the beam sweeping according to the beam sweeping range information to obtain the beam correspondence result.

4. The method of claim 3, wherein the trigger configuration information comprises a preset sweeping trigger threshold; and
wherein determining whether the beam sweeping is to be triggered currently according to the trigger configuration information comprises:
determining a displacement reference value at a current timing relative to a most recent information transmission, wherein the displacement reference value indicates a relative displacement between the base station and the antenna module of the user equipment; and
determining whether the beam sweeping is to be triggered currently by comparing the displacement reference value with the preset sweeping trigger threshold.

5. The method of claim 4, wherein the trigger configuration information further comprises: preset period duration information; and
wherein determining the displacement reference value at the current timing relative to the most recent information transmission comprises:
after the most recent information transmission is completed, in response to detecting that a position of the antenna module relative to the base station has changed, determining the displacement reference value according to the preset period duration information;
wherein the displacement reference value comprises a current moving speed of the UE relative to the base station; the preset sweeping trigger threshold comprises a preset speed threshold; and
wherein determining whether the beam sweeping is to be triggered currently by comparing the displacement reference value with the preset sweeping trigger threshold comprises:
determining whether the current moving speed is greater than or equal to the preset speed threshold;
in response to the current moving speed being greater than or equal to the preset speed threshold, determining that the beam sweeping is to be triggered currently; and
in response to the current moving speed being less than the preset speed threshold, determining that the beam sweeping does not to be triggered currently.

6. (canceled)

7. The method of claim 3, wherein determining the beam sweeping range information comprises:
determining the beam sweeping range information according to preset sweeping range configuration information; or
obtaining the beam sweeping range information issued by the base station;
wherein determining the beam sweeping range information according to the preset sweeping range configuration information comprises:
determining all beams as to-be-swept beams according to the preset sweeping range configuration information; or
determining part of the beams as the to-be-swept beams according to the preset sweeping range configuration information and original matching beam pair information wherein the original matching beam pair information comprises information on a best matching beam pair determined in a most recent information transmission.

8. (canceled)

9. The method of claim 7, wherein the preset sweeping range configuration information comprises: a correspondence between preset displacement deviation value and first preset sweeping range information; and
wherein determining part of the beams as the to-be-swept beams according to the preset sweeping range configuration information and the original matching beam pair information comprises:
determining a difference between a displacement reference value and a preset sweeping threshold to obtain a current displacement deviation value;
determining first preset sweeping range information corresponding to the current displacement deviation value according to the current displacement deviation value and the preset sweeping range configuration information, so as to obtain target sweeping range information; and
determining the to-be-swept beams according to the target sweeping range information and the original matching beam pair information.

10. The method of claim 9, wherein the preset sweeping range configuration information comprises: a correspondence between preset displacement deviation value and first preset coverage angle information; the target sweeping range information comprises: a first target coverage angle which is first preset coverage angle information corresponding to the current displacement deviation value; and
wherein determining the to-be-swept beams according to the target sweeping range information and the original matching beam pair information comprises:
determining a first number of deviation beams according to beam tracking capability information of the user equipment and the first target coverage angle; and
determining the to-be-swept beams according to the original matching beam pair information and the first number of deviation beams.

11. The method of claim 7, wherein the preset sweeping range configuration information comprises: second preset sweeping range information; and
wherein determining part of the beams as the to-be-swept beams according to the preset sweeping range configuration information and the original matching beam pair information comprises:
determining a second number of deviation beams according to the second preset sweeping range information; and
determining the to-be-swept beams according to the original matching beam pair information and the second number of deviation beams;
wherein the second preset sweeping range information comprises: second preset coverage angle information; and
wherein determining the second number of deviation beams according to the second preset sweeping range information comprises:
determining the second number of deviation beams according to beam tracking capability information of the user equipment and the second preset coverage angle information.

12. (canceled)

13. (canceled)

14. The method of claim 7, wherein obtaining the beam sweeping range information issued by the base station comprises:
sending range configuration request information to the base station, wherein the range configuration request information is used to request the base station to configure a beam sweeping range for the user equipment; and
receiving the beam sweeping range information sent by the base station.

15. The method of claim 3, wherein performing the beam sweeping according to the beam sweeping range information to obtain the beam correspondence result comprises:
determining reference signal configuration information of the to-be-swept beams; and
performing the beam sweeping according to the reference signal configuration information and the to-be-swept beams to obtain the beam correspondence result
wherein determining the reference signal configuration information of the to-be-swept beams comprises:
receiving the reference signal configuration information for the to-be-swept beams sent by the base station.

16. (canceled)

17. A beam correspondence method, being applicable in a base station, comprising:
receiving a beam correspondence result sent by user equipment, wherein the beam correspondence result indicates information on a best matching beam pair re-determined after the user equipment performs a beam sweeping in a beam correspondence state; and
determining a transmission beam used for transmitting information between the base station and the user equipment according to the beam correspondence result.

18. The method of claim 17, further comprising:
sending sweeping configuration information to the user equipment under a preset trigger condition;
wherein the sweeping configuration information indicates that in the beam correspondence state, the user equipment performs the beam sweeping to re-determine a best matching beam pair when a relative position between an antenna module of the user equipment and the base station changes, and
the preset trigger condition comprises at least one of the following:
when detecting that the user equipment is connected to a network;
when detecting that the user equipment initiates a millimeter wave module; or
when detecting that the user equipment initiates the antenna module using a millimeter wave frequency band.

19. The method of claim 17, further comprising:
receiving range configuration request information sent by the user equipment, wherein the range configuration request information is used to request the base station to configure a beam sweeping range for the user equipment;
determining beam sweeping range information according to the range configuration request information; and
sending the beam sweeping range information to the user equipment.

20. The method of claim 19, wherein determining the beam sweeping range information comprises:
determining all beams as to-be-swept beams according to preset sweeping range configuration information; or
determining part of the beams as the to-be-swept beams according to the preset sweeping range configuration information and original matching beam pair information, wherein the original matching beam pair information comprises information on a best matching beam pair determined in a most recent information transmission.

21. The method of claim 20, wherein the range configuration request information comprises: a displacement reference value of the user equipment which indicates a relative displacement between an antenna module of the user equipment and the base station;
the preset sweeping range configuration information comprises: a correspondence between preset displacement deviation value and first preset sweeping range information; and
wherein determining part of the beams as the to-be-swept beams according to the preset sweeping range configuration information and the original matching beam pair information comprises:
determining a difference between the displacement reference value and a preset sweeping threshold to obtain a current displacement deviation value;
determining first preset sweeping range information corresponding to the current displacement deviation value according to the current displacement deviation value and preset sweeping range configuration information, so as to obtain target sweeping range information; and
determining the to-be-swept beams according to the target sweeping range information and the original matching beam pair information;
wherein the preset sweeping range configuration information comprises: a correspondence between preset displacement deviation value and first preset coverage angle information; the target sweeping range information comprises: a first target coverage angle which is first preset coverage angle information corresponding to the current displacement deviation value; and
wherein determining the to-be-swept beams according to the target sweeping range information and the original matching beam pair information comprises:
determining a first number of deviation beams according to beam tracking capability information of the user equipment and the first target coverage angle; and
determining the to-be-swept beams according to original matching beam pair information and the first number of deviation beams.

22. (canceled)

23. The method of claim 20, wherein the preset sweeping range configuration information comprises: second preset sweeping range information; and
wherein determining part of the plurality of beams as the to-be-swept beams according to the preset sweeping range configuration information and the original matching beam pair information comprises:
determining a second number of deviation beams according to the second preset sweeping range information; and
determining the to-be-swept beams according to the original matching beam pair information and the second number of deviation beams;
wherein the second preset sweeping range information comprises information on a preset sweeping range determined by the base station according to a maximum displacement reference value of the user equipment.

24. (canceled)

25. (canceled)

26. The method of claim 19, wherein the range configuration request information comprises: beam tracking capability of the user equipment; or
before receiving the range configuration request sent by the user equipment, the method further comprises:
obtaining the beam tracking capability information of the user equipment.

27. The method according to claim 17, further comprising:
sending a transmission beam determination result to the user equipment, such that the user equipment determines whether to use a newly determined best matching beam pair to transmit information.

28.-56. (canceled)

57. User equipment, comprising:
a processor, and
memory for storing instructions executable by the processor;
wherein the processor is configured to:
determine sweeping configuration information for a beam correspondence state, wherein the sweeping configuration information indicates that in the beam correspondence state, the user equipment performs a beam sweeping to re-determine a best matching beam pair when a relative position between an antenna module of the user equipment and a base station changes;
in the beam correspondence state, trigger the beam sweeping according to the sweeping configuration information to obtain a beam correspondence result, wherein the beam sweeping is performed to re-determine the best matching beam pair;
send the beam correspondence result to the base station, so that the base station determines a transmission beam with reference to the beam correspondence result;
wherein when the relative position between the user equipment and the base station changes in the beam correspondence state, the beam sweeping is triggered based on the sweeping configuration information to re-determine the best matching beam pair at a current timing, so as to prepare for subsequent information transmission, and ensure that when millimeter wave band beams are used to transmit information between the user equipment and the base station, best matched beam pairs are employed to transmit information, thereby improving information transmission performance in high-frequency bands.

58. (canceled)
